(19) United States
(12) Patent Application Publication
(10) Pub. No.: US 2025/0171597 A1
(43) Pub. Date: May 29, 2025

(54) HYDROGEL COMPOSITIONS COMPRISING POLYMER-SALT COMPOSITES AND METHODS OF MAKING SAME

(71) Applicant: VIRGINIA TECH INTELLECTUAL PROPERTIES, INC., Blacksburg, VA (US)

(72) Inventors: Curt J. Zanelotti, Downington, PA (US); Deyang Yu, Blacksburg, VA (US); Louis A. Madsen, Blacksburg, VA (US)

(21) Appl. No.: 18/843,595

(22) PCT Filed: Mar. 3, 2023
(86) PCT No.: PCT/US2023/014536

§ 371 Date: Sep. 3, 2024

Related U.S. Application Data
(60) Provisional application No. 63/316,302, filed on Mar. 3, 2022.

(51) Int. Cl. C08J 3/075

(52) U.S. Cl. CPC C08J 3/075; C08J 2377/06

(57) ABSTRACT

In accordance with the purpose(s) of the present disclosure, as embodied and broadly described herein, the disclosure, in one aspect, relates to polymer-salt composite hydrogel compositions comprising an ionic polymer material, a cationic component, and a solvent as disclosed herein. The present disclosure further pertains to the disclosed methods of making the disclosed polymer-salt composite hydrogel compositions, methods of using the disclosed polymer-salt composite hydrogel compositions, and products comprising the disclosed polymer-salt composite hydrogel compositions. This abstract is intended as a scanning tool for purposes of searching in the particular art and is not intended to be limiting of the present disclosure.

### STATEMENT REGARDING FEDERALLY SPONSORED RESEARCH

This invention was made with government support under award grant number EE0008860, awarded by the U.S. Department of Energy, and grant number 1810194, awarded by the U.S. National Science Foundation. The U.S. government has certain rights in the invention.

### BACKGROUND

Hydrogels are a class of soft materials that exhibit many unique tailorable properties, including biocompatibility¹ and stimuli-responsiveness²⁻⁴, that have driven their use in a wide-variety of applications.⁵⁻⁷ These gels are three-dimensional percolated polymeric networks that contain large amounts of water (typically >75 wt %) when swollen.⁸ Due to their high water content, porosity, and soft consistency, hydrogels closely resemble natural living tissue. These properties, along with their generally good biocompatibility and ease of fabrication, make hydrogels desirable for use in a number of biomedical applications. Hydrogels are widely used in forming contact lenses, wound dressings, drug delivery devices, and hygiene products, as well as in tissue engineering. Hydrogels are classified in a variety of ways, but regardless of whether they are formed from natural or synthetic polymers, the crosslinking method remains the simplest and the most influential effect in determining properties obtained.⁹⁻¹¹ Hydrogels can be cross-linked through physical and/or chemical interactions, and these interactions greatly affect the resulting properties.⁹ While chemically cross-linked hydrogels feature high mechanical strength, they also show no stimuli-responsiveness as the crosslinking is permanent in nature.¹²⁻¹³ Physically cross-linked systems, feature non-permanent polymeric interactions resulting in a highly stimuli-responsive system that is usually soft in nature.¹⁴⁻¹⁵ Due to the stimuli-responsive nature of physically cross-linked systems, they can be excellent candidates for drug-delivery, tissue engineering, and 3D-printing, etc.^{4, 9}

Due to reversible physical entanglements or interactions, physically cross-linked hydrogels show extensive self-healing capabilities, but are usually limited by their weak physical strength¹⁶⁻¹⁷ Without additional chemical crosslinkers, the majority of these hydrogels show properties that depend on the intrinsic properties of polymers or small molecules.¹⁷⁻¹⁸ Many of these physically cross-linked systems are formed from natural biopolymers, as they feature long polymeric chains used to extend the length of percolated network. Chitosan and other polysaccharides, such as alginates and pectins, are able to aggregate in dilute aqueous solutions causing a solution-gel transition (sol-gel transition) which solidifies the system.¹⁹ Other natural polymers, including gelatin, cellulose, and collagen, form supramolecular secondary structures in the form of triple-helices.²⁰ These supramolecular structures allow for a drastic increased in the persistence length of an individual polymer rod, as one rod may incorporate many polymer chains.^{6,21} These helical structures allow for the formation of hydrogels at very low polymeric content, <0.05 wt % or 0.5 mg/mL, in which the amount of polymer directly affects the temperature at which the sol-gel transition occurs.⁶ Besides the temperature-sensitivity the amount of polymer used also affects the ability for the system to self-recover, or regain the previous properties once gelled from a melted solution.^{16, 22} Changing hydrogel crosslinking ions, like divalent cations (Ca²⁺ or Zn²⁺), can also drastically change the effective ionic crosslinking in systems formed through ionic interactions with polymers rich in anionic groups.^{18, 23}

However, while hydrogels possess many beneficial properties, they also have some limitations—mainly poor mechanical properties and weak hydrogel-solid interfaces. For example, hydrogels possess low tensile strength which limits their use in applications requiring load-bearing. In such load earing applications, hydrogels are typically unable to maintain their shape and function in the long-term. Further, tissue engineering using hydrogels has generally resulted in hydrogel tissues having significantly poorer mechanical strength than the real tissue. In particular, most hydrogels are brittle and possess very low stretchability. Moreover, formation of weak hydrogel-solid interfaces results in a failure to integrate the soft hydrogel and rigid components with adequate functionality and reliability.

Accordingly, despite advances in hydrogel research, there is still a need for hydrogels that are rigid, thermosensitive, are made by methods that are scalable and utilize materials generally safe for medical or therapeutic application and have a relatively low polymer content. These needs and other needs are met in whole or in part by the present disclosure.

### SUMMARY

The disclosure generally includes physically cross-linked hydrogel formed via ionic associations between a rigid sulfonated aromatic polyamide, poly(2,2′-disulfonyl-4,4′-benzidine terephthalamide) (PBDT), and an ionic solution, like a simple salt solution or ionic liquid (IL). This synthetic polymer is one of the few that undergoes the formation of double helical supramolecular structures in aqueous solution.²⁴ This highly rigid polyelectrolyte features a high persistence length (>2000 nm based on Flory theory of persistence length) which allows for formation of hydrogels at a small concentration. An IL is chosen to be the ion source for ionic association that will physically crosslink the system.

Thus, the disclosure includes a new class of solid electrolyte, termed molecular ionic composites (MIC), composed of ILs and PBDT.²⁵⁻²⁶ These MICs are held together by collective electrostatic interactions between alternating layers of mobile IL cations and anions around the negatively charged rigid PBDT rods.²⁵⁻²⁶ While these MICs show promise as a new solid electrolyte platform²⁹⁻³⁰ they are initially formed highly hydrated, with >40 wt % H₂O that is easily removed by drying before use.

The disclosure includes a “one pot” synthesis method used to make these hydrogels, similar to the method used to produce MIC membranes for use in batteries, as the chosen IL (C₂mimTfO) and PBDT are both miscible in water.²⁸⁻³⁰ Hydrogels produced through this method show high mechanical stiffness and thermo-sensitivity, when compared to other physically cross-linked hydrogels. Rheological hysteresis curves indicate complete self-recovery even at low PBDT content (<0.2 wt %) while NMR experiments enable quantitative determination of the dynamics and populations of ions involved in the ionic associations affecting the sol-gel transition. The PBDT hydrogels thus represent high performance physically cross-linked hydrogels that have widely tunable properties since they can form through the incorporation of various ionic species. Rigid polyelectrolytes, like PBDT, feature the ability to produce solids through the creation of percolated networks through physical crosslinks which allow for fast thermos-reversibility.

In accordance with the purpose(s) of the present disclosure, as embodied and broadly described herein, the disclosure, in one aspect, relates to polymer-salt composite hydrogel compositions comprising an ionic polymer material, a cationic component, and a solvent as disclosed herein. The present disclosure further pertains to the disclosed methods of making the disclosed polymer-salt composite hydrogel compositions, methods of using the disclosed polymer-salt composite hydrogel compositions, and products comprising the disclosed polymer-salt composite hydrogel compositions. The disclosed polymer-salt composite hydrogel compositions can assemble to supramolecular helical fibers and form polymer-salt composite hydrogels after assembly. The corresponding hydrogel can be formed in solutions are rigid, thermosensitive and comprise a high water content/low polymer content. Such hydrogels are useful for cell culture, tissue engineering, and drug release.

Disclosed herein are reversibly rigid polymer-salt composite hydrogel compositions comprising: an ionic polymer material comprising a sulfonated aramid; a cationic component comprising a salt, an ionic liquid, or combinations thereof; and a solvent selected from water, a hydrophilic solvent, a polar solvent, a water-miscible solvent, and combinations thereof; wherein the ionic polymer material is present in an amount of from about 0.1 wt % to about 10.0 wt %; wherein the ion component is present in an amount of from about 0.1 wt % to about 20.0 wt %; and wherein the solvent is present in an amount of from about 70 wt % to about 99.85 wt %; wherein the wt % is based on the weight of the ionic polymer material, the cationic component, and the solvent; and wherein a sum of individual wt % values is 100 wt %.

Also disclosed is a solid reversibly rigid polymer-salt composite hydrogel composition comprising: an ionic polymer material comprising a sulfonated aramid; a cationic component comprising a salt, an ionic liquid, or combinations thereof; a solvent selected from water, a hydrophilic solvent, a polar solvent, a water-miscible solvent, and combinations thereof; wherein the ionic polymer material is present in an amount of from about 0.05 wt % to about 20.0 wt %; wherein the cation component is present in an amount of from about 0.05 wt % to about 20.0 wt %; wherein the solvent is present in an amount of from about 70 wt % to about 99.90 wt %; wherein the wt % is based on the weight of the ionic polymer material, the cationic component, and the solvent; wherein a sum of individual wt % values is 100 wt %; and wherein a storage modulus of the solid reversibly rigid polymer-salt composite hydrogel is greater than a loss modulus of the solid reversibly rigid polymer-salt composite hydrogel as measured by a compressive oscillatory rheology method.

Also disclosed herein are methods of using the disclosed reversibly rigid polymer-salt composite hydrogel compositions.

Also disclosed herein are methods of making the disclosed reversibly rigid polymer-salt composite hydrogel compositions.

Also disclosed herein are articles and/or products comprising the disclosed reversibly rigid polymer-salt composite hydrogel compositions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

Many aspects of the present disclosure can be better understood with reference to the drawings disclosed in the accompanying appendices. The components in these drawings are not necessarily to scale, emphasis instead being placed upon clearly illustrating the principles of the present disclosure. Moreover, in the drawings, like reference numerals designate corresponding parts throughout the several views.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a phase diagram of PBDT and C2mimTfO hydrogels produced at 25° C. Gelation of the systems was confirmed through inversion of the sample vials, ensuring no movement of the solid gel after multiple days. At room temperature, a hydrogel can be formed using just 0.15 wt % PBDT, 8.5 wt % C2mimTfO, and 91.35 wt % H₂O. FIG. 1B shows the mole ratio of the IL cation, C2mim+, to the negatively charged sulfonate group, SO3−, of the PBDT polymer was measured and plotted vs. the wt % of PBDT used. This plot indicates that when a low amount of PBDT is used, a hydrogel will form in the presence of 6 to 60 cations per sulfonate group. At higher PBDT content, the percolated cross-linked network can be created with less IL gelling agent. All wt % s are calculated gravimetrically and have a corresponding error bar of ±1% to the weight that was measured.

FIGS. 2A-2C show phase diagrams of PBDT C2mimTfO hydrogels at four different temperatures according to a visual inversion test. FIG. 2A shows the total phase diagram that describes how the PBDT-C2mimTfO hydrogels formed at 25, 37, 45, 55, and 65° C. These hydrogels indicated thermo-sensitivity, resulting in hydrogels that melted at various temperatures depending on amount of PBDT and IL. The boundaries or lower extremities outlined in the figure (for each color/temperature) describe points above which these systems undergo a sol-gel transition to form a hydrogel. Any points that are made with more IL or PBDT will produce hydrogels if they are above the boundary conditions outlined in the phase diagram. For example, any composition that formed a hydrogel at 55° C. also forms a gel at 25° C. The highest temperature studied, 65° C., was chosen to minimize water evaporation that would fill the headspace of formation vials and result in a hydrogel with an artificially high PBDT and IL concentration. FIG. 2B shows a phase diagram of PBDT-C2mimTfO hydrogels at 65° C. At 65° C., many of the compositions that formed hydrogels at 25° C. transitioned to melts. FIG. 2C shows a plot of the ratios of C2mim+ to SO3− on the PBDT chains that needed to form hydrogels at 65° C. These hydrogels are temperature-dependent.

FIGS. 3A-3B show rheological data for PBDT-C2mimTfO hydrogels. These hydrogels were split into two systematic studies to show the effects on shear modulus and dynamics of the hydrogels for varying PBDT concentration at a constant IL concentration of 5.0 wt %, and varying affect IL concentration at a constant PBDT concentration of 1.5 wt %. Error for each data point was determined through triplicate experiments performed on three different hydrogel discs cut from the same system. FIG. 3A shows moduli of hydrogel samples that had varying PBDT concentration but kept a constant IL wt %=5.0 wt %. A real shear modulus (G′)=14 kPa was obtained at just 1 wt % PBDT indicating a system with high mechanical stiffness at low polymer content for a physically cross-linked system. The data was fit using a power law of 5/2 indicating a physically entangled polymer solution. FIG. 3B shows moduli of hydrogel samples with varying IL concentration while keeping the PBDT content constant at 1.5 wt %. Little change in the modulus was seen for these samples, as all points fall essentially within error of one another. FIG. 3C shows rheological data for two hydrogels at 0.23 wt % and 0.39 wt % PBDT, both containing 5.0 wt % IL. By heating each hydrogel, a temperature-dependent modulus was observed, and as the hydrogel melted at elevated temperatures. After briefly equilibrating at 80° C. for 5 minutes, while cooling the test samples back to room temperature the solution underwent a sol-gel transition. Holding the system at room temperature for 30 min. after the cooling cycle finishes showed a recovery of the original modulus value, completing the hysteresis curve, for the 0.23 wt % PBDT hydrogel. As the PBDT content was increased, the self-recovery rate was increased, as the 0.39 wt % regained its original modulus faster than the 0.23 wt % PBDT hydrogel.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a polymer,” “a solvent,” or “a product,” including, but not limited to, two or more, including plurality, of such polymers, solvents, or products and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the hydrogel composition or material. For example, an “effective amount” of a catalyst, microwave energy, flow rate, and the like, refers to an amount or number that is sufficient to achieve the desired improvement in the property modulated by the component. The specific level in terms of amount or number required as an effective amount will depend upon a variety of factors, e.g., for a given component such factors can include the composition of the catalyst, the flow rate of reactant materials, the composition of the reactant materials, energy constraints, efficiency of an reaction, and the like.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

As embodied and broadly described herein, the disclosure, in one aspect, relates to polymer-salt composite hydrogel compositions comprising an ionic polymer material, a cationic component, and a solvent as disclosed herein.

In an aspect, the disclosure includes a reversibly rigid polymer-salt composite hydrogel composition including an ionic polymer material comprising a sulfonated aramid; a cationic component comprising a salt, an ionic liquid, or combinations thereof; a solvent selected from water, a hydrophilic solvent, a polar solvent, a water-miscible solvent, and combinations thereof; wherein the ionic polymer material is present in an amount of from about 0.05 wt % to about 20.0 wt %; wherein the cationic component is present in an amount of from about 0.05 wt % to about 20.0 wt %; wherein the solvent is present in an amount of from about 70 wt % to about 99.90 wt %; wherein the wt % is based on the weight of the ionic polymer material, the cationic component, and the solvent; and wherein a sum of individual wt % values is 100 wt %.

In an aspect, the sulfonated aramid may be a poly(2,2′-disulfonyl-4,4′-benzidine terephthalamide), a substituted poly(2,2′-disulfonyl-4,4′-benzidine.terephthalamide), a chemically modified poly(2,2′-disulfonyl-4,4′-benzidine terephthalamide), and combinations thereof. In an aspect, the sulfonated aramid may be poly(2,2′-disulfonyl-4,4′-benzidine terephthalamide) also known as PBDT.

In an aspect, the weight average molecular weight of the sulfonated aramid may be from about 10² g/mol to about 10⁶ g/mol, or from about 10² g/mol to about 10⁵ g/mol, or from about 10² g/mol to about 10⁴ g/mol, or from about 10² g/mol to about 10³ g/mol; or from about 10³ g/mol to about 10⁶ g/mol, or from about 10³ g/mol to about 10⁵ g/mol, or from about 10³ g/mol to about 10⁴ g/mol, or from about 10⁴ g/mol to about 10⁶ g/mol, or from about 10⁴ g/mol to about 10⁵ g/mol.

In an aspect, the weight average molecular weight of the sulfonated aramid may be about 1000, or about 1500, or about 2000, or about 2500, or about 3000, or about 3500, or about 4000, or about 4500, or about 5000, or about 5500, or about 6000, or about 6500, or about 7000, or about 7500, or about 8000, or about 8500, or about 9000, or about 9500, or about 10000, or about 10500, or about 11000, or about 11500, or about 12000, or about 12500, or about 13000, or about 13500, or about 14000, or about 14500, or about 15000, or about 15500, or about 16000, or about 16500, or about 17000, or about 17500, or about 18000, or about 18500, or about 19000, or about 19500, or about 20000, or about 20500, or about 21000, or about 21500, or about 22000, or about 22500, or about 23000, or about 23500, or about 24000, or about 24500, or about 25000, or about 25500, or about 26000, or about 26500, or about 27000, or about 27500, or about 28000, or about 28500, or about 29000, or about 29500, or about 30000, or about 30500, or about 31000, or about 31500, or about 32000, or about 32500, or about 33000, or about 33500, or about 34000, or about 34500, or about 35000, or about 35500, or about 36000, or about 36500, or about 37000, or about 37500, or about 38000, or about 38500, or about 39000, or about 39500, or about 40000, or about 40500, or about 41000, or about 41500, or about 42000, or about 42500, or about 43000, or about 43500, or about 44000, or about 44500, or about 45000, or about 45500, or about 46000, or about 46500, or about 47000, or about 47500, or about 48000, or about 48500, or about 49000, or about 49500, or about 50000, or about 50500, or about 51000, or about 51500, or about 52000, or about 52500, or about 53000, or about 53500, or about 54000, or about 54500, or about 55000, or about 55500, or about 56000, or about 56500, or about 57000, or about 57500, or about 58000, or about 58500, or about 59000, or about 59500, or about 60000, or about 60500, or about 61000, or about 61500, or about 62500, or about 62500, or about 63000, or about 63500, or about 64000, or about 64500, or about 65000, or about 65500, or about 66000, or about 66500, or about 67000, or about 67500, or about 68000, or about 68500, or about 69000, or about 69500, or about 70000, or about 70500, or about 71000, or about 71500, or about 72000, or about 72500, or about 73000, or about 73500, or about 74000, or about 74500, or about 75000, or about 75500, or about 76000, or about 76500, or about 77000, or about 77500, or about 78000, or about 78500, or about 79000, or about 79500, or about 80000, or about 80500, or about 81000, or about 81500, or about 82000, or about 82500, or about 83000, or about 83500, or about 84000, or about 84500, or about 85000, or about 85500, or about 86000, or about 86500, or about 87000, or about 87500, or about 88000, or about 88500, or about 89000, or about 89500, or about 90000, or about 90500, or about 91000, or about 91500, or about 92000, or about 92500, or about 93000, or about 93500, or about 94000, or about 94500, or about 95000, or about 95500, or about 96000, or about 96500, or about 97000, or about 97500, or about 98000, or about 98500, or about 99000, or about 99500, or about 100000 or about 100500, or about 101000, or about 101500, or about 102000, or about 102500, or about 103000, or about 103500, or about 104000, or about 104500, or about 105000, or about 105500, or about 106000, or about 106500, or about 107000, or about 107500, or about 108000, or about 108500, or about 109000, or about 109500, or about 110000, or about 110500, or about 111000, or about 111500, or about 112000, or about 112500, or about 113000, or about 113500, or about 114000, or about 114500, or about 115000, or about 115500, or about 116000, or about 116500, or about 117000, or about 117500, or about 118000, or about 118500, or about 119000, or about 119500, or about 120000, or about 120500, or about 121000, or about 121500, or about 122000, or about 122500, or about 123000, or about 123500, or about 124000, or about 124500, or about 125000, or about 125500, or about 126000, or about 126500, or about 127000, or about 127500, or about 128000, or about 128500, or about 129000, or about 129500, or about 130000, or about 130500, or about 131000, or about 131500, or about 132000, or about 132500, or about 133000, or about 133500, or about 134000, or about 134500, or about 135000, or about 135500, or about 136000, or about 136500, or about 137000, or about 137500, or about 138000, or about 138500, or about 139000, or about 139500, or about 140000, or about 140500, or about 141000, or about 141500, or about 142000, or about 142500, or about 143000, or about 143500, or about 144000, or about 144500, or about 145000, or about 145500, or about 146000, or about 146500, or about 147000, or about 147500, or about 148000, or about 148500, or about 149000, or about 149500, or about 150000, or about 150500, or about 151000, or about 151500, or about 152000, or about 152500, or about 153000, or about 153500, or about 154000, or about 154500, or about 155000, or about 155500, or about 156000, or about 156500, or about 157000, or about 157500, or about 158000, or about 158500, or about 159000, or about 159500, or about 160000, or about 160500, or about 161000, or about 161500, or about 162500, or about 162500, or about 163000, or about 163500, or about 164000, or about 164500, or about 165000, or about 165500, or about 166000, or about 166500, or about 167000, or about 167500, or about 168000, or about 168500, or about 169000, or about 169500, or about 170000, or about 170500, or about 171000, or about 171500, or about 172000, or about 172500, or about 173000, or about 173500, or about 174000, or about 174500, or about 175000, or about 175500, or about 176000, or about 176500, or about 177000, or about 177500, or about 178000, or about 178500, or about 179000, or about 179500, or about 180000, or about 180500, or about 181000, or about 181500, or about 182000, or about 182500, or about 183000, or about 183500, or about 184000, or about 184500, or about 185000, or about 185500, or about 186000, or about 186500, or about 187000, or about 187500, or about 188000, or about 188500, or about 189000, or about 189500, or about 190000, or about 190500, or about 191000, or about 191500, or about 192000, or about 192500, or about 193000, or about 193500, or about 194000, or about 194500, or about 195000, or about 195500, or about 196000, or about 196500, or about 197000, or about 197500, or about 198000, or about 198500, or about 199000, or about 199500, or about 200000, or about 200500, or about 201000, or about 201500, or about 202000, or about 202500, or about 203000, or about 203500, or about 204000, or about 204500, or about 205000, or about 205500, or about 206000, or about 206500, or about 207000, or about 207500, or about 208000, or about 208500, or about 209000, or about 209500, or about 210000, or about 210500, or about 211000, or about 211500, or about 212000, or about 212500, or about 213000, or about 213500, or about 214000, or about 214500, or about 215000, or about 215500, or about 216000, or about 216500, or about 217000, or about 217500, or about 218000, or about 218500, or about 219000, or about 219500, or about 220000, or about 220500, or about 221000, or about 221500, or about 222000, or about 222500, or about 223000, or about 223500, or about 224000, or about 224500, or about 225000, or about 225500, or about 226000, or about 226500, or about 227000, or about 227500, or about 228000, or about 228500, or about 229000, or about 229500, or about 230000, or about 230500, or about 231000, or about 231500, or about 232000, or about 232500, or about 233000, or about 233500, or about 234000, or about 234500, or about 235000, or about 235500, or about 236000, or about 236500, or about 237000, or about 237500, or about 238000, or about 238500, or about 239000, or about 239500, or about 240000, or about 240500, or about 241000, or about 241500, or about 242000, or about 242500, or about 243000, or about 243500, or about 244000, or about 244500, or about 245000, or about 245500, or about 246000, or about 246500, or about 247000, or about 247500, or about 248000, or about 248500, or about 249000, or about 249500, or about 250000, or about 250500, or about 251000, or about 251500, or about 252000, or about 252500, or about 253000, or about 253500, or about 254000, or about 254500, or about 255000, or about 255500, or about 256000, or about 256500, or about 257000, or about 257500, or about 258000, or about 258500, or about 259000, or about 259500, or about 260000, or about 260500, or about 261000, or about 261500, or about 262500, or about 262500, or about 263000, or about 263500, or about 264000, or about 264500, or about 265000, or about 265500, or about 266000, or about 266500, or about 267000, or about 267500, or about 268000, or about 268500, or about 269000, or about 269500, or about 270000, or about 270500, or about 271000, or about 271500, or about 272000, or about 272500, or about 273000, or about 273500, or about 274000, or about 274500, or about 275000, or about 275500, or about 276000, or about 276500, or about 277000, or about 277500, or about 278000, or about 278500, or about 279000, or about 279500, or about 280000, or about 280500, or about 281000, or about 281500, or about 282000, or about 282500, or about 283000, or about 283500, or about 284000, or about 284500, or about 285000, or about 285500, or about 286000, or about 286500, or about 287000, or about 287500, or about 288000, or about 288500, or about 289000, or about 289500, or about 290000, or about 290500, or about 291000, or about 291500, or about 292000, or about 292500, or about 293000, or about 293500, or about 294000, or about 294500, or about 295000, or about 295500, or about 296000, or about 296500, or about 297000, or about 297500, or about 298000, or about 298500, or about 299000, or about 299500, or about 300000, or about 300500, or about 301000, or about 301500, or about 302000, or about 302500, or about 303000, or about 303500, or about 304000, or about 304500, or about 305000, or about 305500, or about 306000, or about 306500, or about 307000, or about 307500, or about 308000, or about 308500, or about 309000, or about 309500, or about 310000, or about 310500, or about 311000, or about 311500, or about 312000, or about 312500, or about 313000, or about 313500, or about 314000, or about 314500, or about 315000, or about 315500, or about 316000, or about 316500, or about 317000, or about 317500, or about 318000, or about 318500, or about 319000, or about 319500, or about 320000, or about 320500, or about 321000, or about 321500, or about 322000, or about 322500, or about 323000, or about 323500, or about 324000, or about 324500, or about 325000, or about 325500, or about 326000, or about 326500, or about 327000, or about 327500, or about 328000, or about 328500, or about 329000, or about 329500, or about 330000, or about 330500, or about 331000, or about 331500, or about 332000, or about 332500, or about 333000, or about 333500, or about 334000, or about 334500, or about 335000, or about 335500, or about 336000, or about 336500, or about 337000, or about 337500, or about 338000, or about 338500, or about 339000, or about 339500, or about 340000, or about 340500, or about 341000, or about 341500, or about 342000, or about 342500, or about 343000, or about 343500, or about 344000, or about 344500, or about 345000, or about 345500, or about 346000, or about 346500, or about 347000, or about 347500, or about 348000, or about 348500, or about 349000, or about 349500, or about 350000, or about 350500, or about 351000, or about 351500, or about 352000, or about 352500, or about 353000, or about 353500, or about 354000, or about 354500, or about 355000, or about 355500, or about 356000, or about 356500, or about 357000, or about 357500, or about 358000, or about 358500, or about 359000, or about 359500, or about 360000, or about 360500, or about 361000, or about 361500, or about 362500, or about 362500, or about 363000, or about 363500, or about 364000, or about 364500, or about 365000, or about 365500, or about 366000, or about 366500, or about 367000, or about 367500, or about 368000, or about 368500, or about 369000, or about 369500, or about 370000, or about 370500, or about 371000, or about 371500, or about 372000, or about 372500, or about 373000, or about 373500, or about 374000, or about 374500, or about 375000, or about 375500, or about 376000, or about 376500, or about 377000, or about 377500, or about 378000, or about 378500, or about 379000, or about 379500, or about 380000, or about 380500, or about 381000, or about 381500, or about 382000, or about 382500, or about 383000, or about 383500, or about 384000, or about 384500, or about 385000, or about 385500, or about 386000, or about 386500, or about 387000, or about 387500, or about 388000, or about 388500, or about 389000, or about 389500, or about 390000, or about 390500, or about 391000, or about 391500, or about 392000, or about 392500, or about 393000, or about 393500, or about 394000, or about 394500, or about 395000, or about 395500, or about 396000, or about 396500, or about 397000, or about 397500, or about 398000, or about 398500, or about 399000, or about 399500, or about 400000, or about 400500, or about 401000, or about 401500, or about 402000, or about 402500, or about 403000, or about 403500, or about 404000, or about 404500, or about 405000, or about 405500, or about 406000, or about 406500, or about 407000, or about 407500, or about 408000, or about 408500, or about 409000, or about 409500, or about 410000, or about 410500, or about 411000, or about 411500, or about 412000, or about 412500, or about 413000, or about 413500, or about 414000, or about 414500, or about 415000, or about 415500, or about 416000, or about 416500, or about 417000, or about 417500, or about 418000, or about 418500, or about 419000, or about 419500, or about 420000, or about 420500, or about 421000, or about 421500, or about 422000, or about 422500, or about 423000, or about 423500, or about 424000, or about 424500, or about 425000, or about 425500, or about 426000, or about 426500, or about 427000, or about 427500, or about 428000, or about 428500, or about 429000, or about 429500, or about 430000, or about 430500, or about 431000, or about 431500, or about 432000, or about 432500, or about 433000, or about 433500, or about 434000, or about 434500, or about 435000, or about 435500, or about 436000, or about 436500, or about 437000, or about 437500, or about 438000, or about 438500, or about 439000, or about 439500, or about 440000, or about 440500, or about 441000, or about 441500, or about 442000, or about 442500, or about 443000, or about 443500, or about 444000, or about 444500, or about 445000, or about 445500, or about 446000, or about 446500, or about 447000, or about 447500, or about 448000, or about 448500, or about 449000, or about 449500, or about 450000, or about 450500, or about 451000, or about 451500, or about 452000, or about 452500, or about 453000, or about 453500, or about 454000, or about 454500, or about 455000, or about 455500, or about 456000, or about 456500, or about 457000, or about 457500, or about 458000, or about 458500, or about 459000, or about 459500, or about 460000, or about 460500, or about 461000, or about 461500, or about 462500, or about 462500, or about 463000, or about 463500, or about 464000, or about 464500, or about 465000, or about 465500, or about 466000, or about 466500, or about 467000, or about 467500, or about 468000, or about 468500, or about 469000, or about 469500, or about 470000, or about 470500, or about 471000, or about 471500, or about 472000, or about 472500, or about 473000, or about 473500, or about 474000, or about 474500, or about 475000, or about 475500, or about 476000, or about 476500, or about 477000, or about 477500, or about 478000, or about 478500, or about 479000, or about 479500, or about 480000, or about 480500, or about 481000, or about 481500, or about 482000, or about 482500, or about 483000, or about 483500, or about 484000, or about 484500, or about 485000, or about 485500, or about 486000, or about 486500, or about 487000, or about 487500, or about 488000, or about 488500, or about 489000, or about 489500, or about 490000, or about 490500, or about 491000, or about 491500, or about 492000, or about 492500, or about 493000, or about 493500, or about 494000, or about 494500, or about 495000, or about 495500, or about 496000, or about 496500, or about 497000, or about 497500, or about 498000, or about 498500, or about 499000, or about 499500, or about 500000, or about 500500, or about 501000, or 501500, or about 502000, or about 502500, or about 503000, or about 503500, or about 504000, or about 504500, or about 505000, or about 505500, or about 506000, or about 506500, or about 507000, or about 507500, or about 508000, or about 508500, or about 509000, or about 509500, or about 510000, or about 510500, or about 511000, or about 511500, or about 512000, or about 512500, or about 513000, or about 513500, or about 514000, or about 514500, or about 515000, or about 515500, or about 516000, or about 516500, or about 517000, or about 517500, or about 518000, or about 518500, or about 519000, or about 519500, or about 520000, or about 520500, or about 521000, or about 521500, or about 522000, or about 522500, or about 523000, or about 523500, or about 524000, or about 524500, or about 525000, or about 525500, or about 526000, or about 526500, or about 527000, or about 527500, or about 528000, or about 528500, or about 529000, or about 529500, or about 530000, or about 530500, or about 531000, or about 531500, or about 532000, or about 532500, or about 533000, or about 533500, or about 534000, or about 534500, or about 535000, or about 535500, or about 536000, or about 536500, or about 537000, or about 537500, or about 538000, or about 538500, or about 539000, or about 539500, or about 540000, or about 540500, or about 541000, or about 541500, or about 542000, or about 542500, or about 543000, or about 543500, or about 544000, or about 544500, or about 545000, or about 545500, or about 546000, or about 546500, or about 547000, or about 547500, or about 548000, or about 548500, or about 549000, or about 549500, or about 550000, or about 550500, or about 551000, or about 551500, or about 552000, or about 552500, or about 553000, or about 553500, or about 554000, or about 554500, or about 555000, or about 555500, or about 556000, or about 556500, or about 557000, or about 557500, or about 558000, or about 558500, or about 559000, or about 559500, or about 560000, or about 560500, or about 561000, or about 561500, or about 562500, or about 562500, or about 563000, or about 563500, or about 564000, or about 564500, or about 565000, or about 565500, or about 566000, or about 566500, or about 567000, or about 567500, or about 568000, or about 568500, or about 569000, or about 569500, or about 570000, or about 570500, or about 571000, or about 571500, or about 572000, or about 572500, or about 573000, or about 573500, or about 574000, or about 574500, or about 575000, or about 575500, or about 576000, or about 576500, or about 577000, or about 577500, or about 578000, or about 578500, or about 579000, or about 579500, or about 580000, or about 580500, or about 581000, or about 581500, or about 582000, or about 582500, or about 583000, or about 583500, or about 584000, or about 584500, or about 585000, or about 585500, or about 586000, or about 586500, or about 587000, or about 587500, or about 588000, or about 588500, or about 589000, or about 589500, or about 590000, or about 590500, or about 591000, or about 591500, or about 592000, or about 592500, or about 593000, or about 593500, or about 594000, or about 594500, or about 595000, or about 595500, or about 596000, or about 596500, or about 597000, or about 597500, or about 598000, or about 598500, or about 599000, or about 599500, or about 600000, or about 600500, or about 601000, or about 601500, or about 602000, or about 602500, or about 603000, or about 603500, or about 604000, or about 604500, or about 605000, or about 605500, or about 606000, or about 606500, or about 607000, or about 607500, or about 608000, or about 608500, or about 609000, or about 609500, or about 610000, or about 610500, or about 611000, or about 611500, or about 612000, or about 612500, or about 613000, or about 613500, or about 614000, or about 614500, or about 615000, or about 615500, or about 616000, or about 616500, or about 617000, or about 617500, or about 618000, or about 618500, or about 619000, or about 619500, or about 620000, or about 620500, or about 621000, or about 621500, or about 622000, or about 622500, or about 623000, or about 623500, or about 624000, or about 624500, or about 625000, or about 625500, or about 626000, or about 626500, or about 627000, or about 627500, or about 628000, or about 628500, or about 629000, or about 629500, or about 630000, or about 630500, or about 631000, or about 631500, or about 632000, or about 632500, or about 633000, or about 633500, or about 634000, or about 634500, or about 635000, or about 635500, or about 636000, or about 636500, or about 637000, or about 637500, or about 638000, or about 638500, or about 639000, or about 639500, or about 640000, or about 640500, or about 641000, or about 641500, or about 642000, or about 642500, or about 643000, or about 643500, or about 644000, or about 644500, or about 645000, or about 645500, or about 646000, or about 646500, or about 647000, or about 647500, or about 648000, or about 648500, or about 649000, or about 649500, or about 650000, or about 650500, or about 651000, or about 651500, or about 652000, or about 652500, or about 653000, or about 653500, or about 654000, or about 654500, or about 655000, or about 655500, or about 656000, or about 656500, or about 657000, or about 657500, or about 658000, or about 658500, or about 659000, or about 659500, or about 660000, or about 660500, or about 661000, or about 661500, or about 662500, or about 662500, or about 663000, or about 663500, or about 664000, or about 664500, or about 665000, or about 665500, or about 666000, or about 666500, or about 667000, or about 667500, or about 668000, or about 668500, or about 669000, or about 669500, or about 670000, or about 670500, or about 671000, or about 671500, or about 672000, or about 672500, or about 673000, or about 673500, or about 674000, or about 674500, or about 675000, or about 675500, or about 676000, or about 676500, or about 677000, or about 677500, or about 678000, or about 678500, or about 679000, or about 679500, or about 680000, or about 680500, or about 681000, or about 681500, or about 682000, or about 682500, or about 683000, or about 683500, or about 684000, or about 684500, or about 685000, or about 685500, or about 686000, or about 686500, or about 687000, or about 687500, or about 688000, or about 688500, or about 689000, or about 689500, or about 690000, or about 690500, or about 691000, or about 691500, or about 692000, or about 692500, or about 693000, or about 693500, or about 694000, or about 694500, or about 695000, or about 695500, or about 696000, or about 696500, or about 697000, or about 697500, or about 698000, or about 698500, or about 699000, or about 699500, or about 700000, or about 700500, or about 701000, or about 701500, or about 702000, or about 702500, or about 703000, or about 703500, or about 704000, or about 704500, or about 705000, or about 705500, or about 706000, or about 706500, or about 707000, or about 707500, or about 708000, or about 708500, or about 709000, or about 709500, or about 710000, or about 710500, or about 711000, or about 711500, or about 712000, or about 712500, or about 713000, or about 713500, or about 714000, or about 714500, or about 715000, or about 715500, or about 716000, or about 716500, or about 717000, or about 717500, or about 718000, or about 718500, or about 719000, or about 719500, or about 720000, or about 720500, or about 721000, or about 721500, or about 722000, or about 722500, or about 723000, or about 723500, or about 724000, or about 724500, or about 725000, or about 725500, or about 726000, or about 726500, or about 727000, or about 727500, or about 728000, or about 728500, or about 729000, or about 729500, or about 730000, or about 730500, or about 731000, or about 731500, or about 732000, or about 732500, or about 733000, or about 733500, or about 734000, or about 734500, or about 735000, or about 735500, or about 736000, or about 736500, or about 737000, or about 737500, or about 738000, or about 738500, or about 739000, or about 739500, or about 740000, or about 740500, or about 741000, or about 741500, or about 742000, or about 742500, or about 743000, or about 743500, or about 744000, or about 744500, or about 745000, or about 745500, or about 746000, or about 746500, or about 747000, or about 747500, or about 748000, or about 748500, or about 749000, or about 749500, or about 750000, or about 750500, or about 751000, or about 751500, or about 752000, or about 752500, or about 753000, or about 753500, or about 754000, or about 754500, or about 755000, or about 755500, or about 756000, or about 756500, or about 757000, or about 757500, or about 758000, or about 758500, or about 759000, or about 759500, or about 760000, or about 760500, or about 761000, or about 761500, or about 762500, or about 762500, or about 763000, or about 763500, or about 764000, or about 764500, or about 765000, or about 765500, or about 766000, or about 766500, or about 767000, or about 767500, or about 768000, or about 768500, or about 769000, or about 769500, or about 770000, or about 770500, or about 771000, or about 771500, or about 772000, or about 772500, or about 773000, or about 773500, or about 774000, or about 774500, or about 775000, or about 775500, or about 776000, or about 776500, or about 777000, or about 777500, or about 778000, or about 778500, or about 779000, or about 779500, or about 780000, or about 780500, or about 781000, or about 781500, or about 782000, or about 782500, or about 783000, or about 783500, or about 784000, or about 784500, or about 785000, or about 785500, or about 786000, or about 786500, or about 787000, or about 787500, or about 788000, or about 788500, or about 789000, or about 789500, or about 790000, or about 790500, or about 791000, or about 791500, or about 792000, or about 792500, or about 793000, or about 793500, or about 794000, or about 794500, or about 795000, or about 795500, or about 796000, or about 796500, or about 797000, or about 797500, or about 798000, or about 798500, or about 799000, or about 799500, or about 800000, or about 800500, or about 801000, or about 801500, or about 802000, or about 802500, or about 803000, or about 803500, or about 804000, or about 804500, or about 805000, or about 805500, or about 806000, or about 806500, or about 807000, or about 807500, or about 808000, or about 808500, or about 809000, or about 809500, or about 810000, or about 810500, or about 811000, or about 811500, or about 812000, or about 812500, or about 813000, or about 813500, or about 814000, or about 814500, or about 815000, or about 815500, or about 816000, or about 816500, or about 817000, or about 817500, or about 818000, or about 818500, or about 819000, or about 819500, or about 820000, or about 820500, or about 821000, or about 821500, or about 822000, or about 822500, or about 823000, or about 823500, or about 824000, or about 824500, or about 825000, or about 825500, or about 826000, or about 826500, or about 827000, or about 827500, or about 828000, or about 828500, or about 829000, or about 829500, or about 830000, or about 830500, or about 831000, or about 831500, or about 832000, or about 832500, or about 833000, or about 833500, or about 834000, or about 834500, or about 835000, or about 835500, or about 836000, or about 836500, or about 837000, or about 837500, or about 838000, or about 838500, or about 839000, or about 839500, or about 840000, or about 840500, or about 841000, or about 841500, or about 842000, or about 842500, or about 843000, or about 843500, or about 844000, or about 844500, or about 845000, or about 845500, or about 846000, or about 846500, or about 847000, or about 847500, or about 848000, or about 848500, or about 849000, or about 849500, or about 850000, or about 850500, or about 851000, or about 851500, or about 852000, or about 852500, or about 853000, or about 853500, or about 854000, or about 854500, or about 855000, or about 855500, or about 856000, or about 856500, or about 857000, or about 857500, or about 858000, or about 858500, or about 859000, or about 859500, or about 860000, or about 860500, or about 861000, or about 861500, or about 862500, or about 862500, or about 863000, or about 863500, or about 864000, or about 864500, or about 865000, or about 865500, or about 866000, or about 866500, or about 867000, or about 867500, or about 868000, or about 868500, or about 869000, or about 869500, or about 870000, or about 870500, or about 871000, or about 871500, or about 872000, or about 872500, or about 873000, or about 873500, or about 874000, or about 874500, or about 875000, or about 875500, or about 876000, or about 876500, or about 877000, or about 877500, or about 878000, or about 878500, or about 879000, or about 879500, or about 880000, or about 880500, or about 881000, or about 881500, or about 882000, or about 882500, or about 883000, or about 883500, or about 884000, or about 884500, or about 885000, or about 885500, or about 886000, or about 886500, or about 887000, or about 887500, or about 888000, or about 888500, or about 889000, or about 889500, or about 890000, or about 890500, or about 891000, or about 891500, or about 892000, or about 892500, or about 893000, or about 893500, or about 894000, or about 894500, or about 895000, or about 895500, or about 896000, or about 896500, or about 897000, or about 897500, or about 898000, or about 898500, or about 899000, or about 899500, or about 900000, or about 900500, or about 901000, or about 901500, or about 902000, or about 902500, or about 903000, or about 903500, or about 904000, or about 904500, or about 905000, or about 905500, or about 906000, or about 906500, or about 907000, or about 907500, or about 908000, or about 908500, or about 909000, or about 909500, or about 910000, or about 910500, or about 911000, or about 911500, or about 912000, or about 912500, or about 913000, or about 913500, or about 914000, or about 914500, or about 915000, or about 915500, or about 916000, or about 916500, or about 917000, or about 917500, or about 918000, or about 918500, or about 919000, or about 919500, or about 920000, or about 920500, or about 921000, or about 921500, or about 922000, or about 922500, or about 923000, or about 923500, or about 924000, or about 924500, or about 925000, or about 925500, or about 926000, or about 926500, or about 927000, or about 927500, or about 928000, or about 928500, or about 929000, or about 929500, or about 930000, or about 930500, or about 931000, or about 931500, or about 932000, or about 932500, or about 933000, or about 933500, or about 934000, or about 934500, or about 935000, or about 935500, or about 936000, or about 936500, or about 937000, or about 937500, or about 938000, or about 938500, or about 939000, or about 939500, or about 940000, or about 940500, or about 941000, or about 941500, or about 942000, or about 942500, or about 943000, or about 943500, or about 944000, or about 944500, or about 945000, or about 945500, or about 946000, or about 946500, or about 947000, or about 947500, or about 948000, or about 948500, or about 949000, or about 949500, or about 950000, or about 950500, or about 951000, or about 951500, or about 952000, or about 952500, or about 953000, or about 953500, or about 954000, or about 954500, or about 955000, or about 955500, or about 956000, or about 956500, or about 957000, or about 957500, or about 958000, or about 958500, or about 959000, or about 959500, or about 960000, or about 960500, or about 961000, or about 961500, or about 962500, or about 962500, or about 963000, or about 963500, or about 964000, or about 964500, or about 965000, or about 965500, or about 966000, or about 966500, or about 967000, or about 967500, or about 968000, or about 968500, or about 969000, or about 969500, or about 970000, or about 970500, or about 971000, or about 971500, or about 972000, or about 972500, or about 973000, or about 973500, or about 974000, or about 974500, or about 975000, or about 975500, or about 976000, or about 976500, or about 977000, or about 977500, or about 978000, or about 978500, or about 979000, or about 979500, or about 980000, or about 980500, or about 981000, or about 981500, or about 982000, or about 982500, or about 983000, or about 983500, or about 984000, or about 984500, or about 985000, or about 985500, or about 986000, or about 986500, or about 987000, or about 987500, or about 988000, or about 988500, or about 989000, or about 989500, or about 990000, or about 990500, or about 991000, or about 991500, or about 992000, or about 992500, or about 993000, or about 993500, or about 994000, or about 994500, or about 995000, or about 995500, or about 996000, or about 996500, or about 997000, or about 997500, or about 998000, or about 998500, or about 999000, or about 999500, or about 1000000 g/mol. In the forgoing array of numbers, the weight average molecular weight may fall in a range of numbers from one number to another number. For example, the weight average molecular weight may be in a range from about 60000 g/mol to about 85500 g/mol.

In an aspect, the sulfonated aramid has a polydispersity index of about, 1.0, or about 1.1, or about 1.2, or about 1.3, or about 1.4, or about 1.5, or about 1.6, or about 1.7, or about 1.8, or about 1.9, or about 2.0, or about 2.1, or about 2.2, or about 2.3, or about 2.4, or about 2.5, or about 2.6, or about 2.7, or about 2.8, or about 2.9, or about 3.0, or about 3.1, or about 3.2, or about 3.3, or about 3.4, or about 3.5, or about 3.6, or about 3.7, or about 3.8, or about 3.9, or about 4.0, or about 4.1, or about 4.2, or about 4.3, or about 4.4, or about 4.5, or about 4.6, or about 4.7, or about 4.8, or about 4.9, or about 5.0, or about 5.1, or about 5.2, or about 5.3, or about 5.4, or about 5.5, or about 5.6, or about 5.7, or about 5.8, or about 5.9, or about 6.0. In the forgoing array of numbers, the polydispersity index may fall in a range of numbers from one number to another number. For example, the polydispersity index may be in a range from about 3.9 to about 5.0.

In an aspect, the ionic polymer material may be about 0.05, or about 0.1, or about or about 0.2, or about 0.3, or about 0.4, or about 0.5, or about 0.6, or about 0.7, or about or about 0.8, or about 0.9, or about 1.0, or about 1.1, or about 1.2, or about 1.3, or about 1.4, or about 1.5, or about 1.6, or about 1.7, or about 1.8, or about 1.9, or about 2.0, or about 2.1, or about 2.2, or about 2.3, or about 2.4, or about 2.5, or about 2.6, or about 2.7, or about 2.8, or about 2.9, or about 3.0, or about 3.1, or about 3.2, or about 3.3, or about 3.4, or about 3.5, or about 3.6, or about 3.7, or about 3.8, or about 3.9, or about 4.0, or about 4.1, or about 4.2, or about 4.3, or about 4.4, or about 4.5, or about 4.6, or about 4.7, or about 4.8, or about 4.9, or about 5.0, or about 5.1, or about 5.2, or about 5.3, or about 5.4, or about 5.5, or about 5.6, or about 5.7, or about 5.8, or about 5.9, or about 6.0, or about 6.1, or about 6.2, or about 6.3, or about 6.4, or about 6.5, or about 6.6, or about 6.7, or about 6.8, or about 6.9, or about 7.0, or about 7.1, or about 7.2, or about 7.3, or about 7.4, or about 7.5, or about 7.6, or about 7.7, or about 7.8, or about 7.9, or about 8.0, or about 8.1, or about 8.2, or about 8.3, or about 8.4, or about 8.5, or about 8.6, or about 8.7, or about 8.8, or about 8.9, or about 9.0, or about 9.1, or about 9.2, or about 9.3, or about 9.4, or about 9.5, or about 9.6, or about 9.7, or about 9.8, or about 9.9, or about 10.0, or about 10.1, or about 10.2, or about 10.3, or about 10.4, or about 10.5, or about 10.6, or about 10.7, or about 10.8, or about 10.9, or about 11.0, or about 11.1, or about 11.2, or about 11.3, or about 11.4, or about 11.5, or about 11.6, or about 11.7, or about 11.8, or about 11.9, or about 12.0, or about 12.1, or about 12.2, or about 12.3, or about 12.4, or about 12.5, or about 12.6, or about 12.7, or about 12.8, or about 12.9, or about 13.0, or about 13.1, or about 13.2, or about 13.3, or about 13.4, or about 13.5, or about 13.6, or about 13.7, or about 13.8, or about 13.9, or about 14.0, or about 14.1, or about 14.2, or about 14.3, or about 14.4, or about 14.5, or about 14.6, or about 14.7, or about 14.8, or about 14.9, or about 15.0, or about 15.1, or about 15.2, or about 15.3, or about 15.4, or about 15.5, or about 15.6, or about 15.7, or about 15.8, or about 15.9, or about 16.0, or about 16.1, or about 16.2, or about 16.3, or about 16.4, or about 16.5, or about 16.6, or about 16.7, or about 16.8, or about 16.9, or about 17.0, or about 17.1, or about 17.2, or about 17.3, or about 17.4, or about 17.5, or about 17.6, or about 17.7, or about 17.8, or about 17.9, or about 18.0, or about 18.1, or about 18.2, or about 18.3, or about 18.4, or about 18.5, or about 18.6, or about 18.7, or about 18.8, or about 18.9, or about 19.0, or about 19.1, or about 19.2, or about 19.3, or about 19.4, or about 19.5, or about 19.6, or about 19.7, or about 19.8, or about 19.9, or about 20.0percent by weight of the composite hydrogel composition. In the forgoing array of numbers, percent by weight of the ionic polymer material may fall in a range of numbers from one number to another number. For example, the percent by weight of the ionic polymer material may be in a range from about 6.9 to about 11.3 percent.

In an aspect, the cationic component may be about 0.05, or about 0.1, or about or about 0.2, or about 0.3, or about 0.4, or about 0.5, or about 0.6, or about 0.7, or about or about 0.8, or about 0.9, or about 1.0, or about 1.1, or about 1.2, or about 1.3, or about 1.4, or about 1.5, or about 1.6, or about 1.7, or about 1.8, or about 1.9, or about 2.0, or about 2.1, or about 2.2, or about 2.3, or about 2.4, or about 2.5, or about 2.6, or about 2.7, or about 2.8, or about 2.9, or about 3.0, or about 3.1, or about 3.2, or about 3.3, or about 3.4, or about 3.5, or about 3.6, or about 3.7, or about 3.8, or about 3.9, or about 4.0, or about 4.1, or about 4.2, or about 4.3, or about 4.4, or about 4.5, or about 4.6, or about 4.7, or about 4.8, or about 4.9, or about 5.0, or about 5.1, or about 5.2, or about 5.3, or about 5.4, or about 5.5, or about 5.6, or about 5.7, or about 5.8, or about 5.9, or about 6.0, or about 6.1, or about 6.2, or about 6.3, or about 6.4, or about 6.5, or about 6.6, or about 6.7, or about 6.8, or about 6.9, or about 7.0, or about 7.1, or about 7.2, or about 7.3, or about 7.4, or about 7.5, or about 7.6, or about 7.7, or about 7.8, or about 7.9, or about 8.0, or about 8.1, or about 8.2, or about 8.3, or about 8.4, or about 8.5, or about 8.6, or about 8.7, or about 8.8, or about 8.9, or about 9.0, or about 9.1, or about 9.2, or about 9.3, or about 9.4, or about 9.5, or about 9.6, or about 9.7, or about 9.8, or about 9.9, or about 10.0, or about 10.1, or about 10.2, or about 10.3, or about 10.4, or about 10.5, or about 10.6, or about 10.7, or about 10.8, or about 10.9, or about 11.0, or about 11.1, or about 11.2, or about 11.3, or about 11.4, or about 11.5, or about 11.6, or about 11.7, or about 11.8, or about 11.9, or about 12.0, or about 12.1, or about 12.2, or about 12.3, or about 12.4, or about 12.5, or about 12.6, or about 12.7, or about 12.8, or about 12.9, or about 13.0, or about 13.1, or about 13.2, or about 13.3, or about 13.4, or about 13.5, or about 13.6, or about 13.7, or about 13.8, or about 13.9, or about 14.0, or about 14.1, or about 14.2, or about 14.3, or about 14.4, or about 14.5, or about 14.6, or about 14.7, or about 14.8, or about 14.9, or about 15.0, or about 15.1, or about 15.2, or about 15.3, or about 15.4, or about 15.5, or about 15.6, or about 15.7, or about 15.8, or about 15.9, or about 16.0, or about 16.1, or about 16.2, or about 16.3, or about 16.4, or about 16.5, or about 16.6, or about 16.7, or about 16.8, or about 16.9, or about 17.0, or about 17.1, or about 17.2, or about 17.3, or about 17.4, or about 17.5, or about 17.6, or about 17.7, or about 17.8, or about 17.9, or about 18.0, or about 18.1, or about 18.2, or about 18.3, or about 18.4, or about 18.5, or about 18.6, or about 18.7, or about 18.8, or about 18.9, or about 19.0, or about 19.1, or about 19.2, or about 19.3, or about 19.4, or about 19.5, or about 19.6, or about 19.7, or about 19.8, or about 19.9, or about 20.0 percent by weight of the composite hydrogel composition. In the forgoing array of numbers, percent by weight of the cationic component may fall in a range of numbers from one number to another number. For example, the percent by weight of the ionic polymer material may be in a range from about 0.3 to about 10.0 percent.

In an aspect, in the composite hydrogel composite, the solvent may about 70, or about 71, or about 72, or about 73, or about 74, or about 75, or about 76, or about 77, or about 78, or about 79, or about 80, or about 81, or about 82, or about 83, or about 84, or about 85, or about 86, or about 87, or about 88, or about 89, or about 90.0, or about 90.1, or about 90.2, or about 90.3, or about 90.4, or about 90.5, or about 90.6, or about 90.7, or about 90.8, or about 90.9, or about 91.0, about 91.1 or about 91.2, or about 91.3, or about 91.4, or about 91.5, or about 91.6, or about 91.7, or about 91.8, or about 91.9, or about 92.0, or about 92.1 or about 92.2, or about 92.3, or about 92.4, or about 92.5, or about 92.6, or about 92.7, or about 92.8, or about 92.9, or about 93.0, or about 93.1 or about 93.2, or about 93.3, or about 93.4, or about 93.5, or about 93.6, or about 93.7, or about 93.8, or about 93.9, or about 94.0, or about 94.1 or about 94.2, or about 94.3, or about 94.4, or about 94.5, or about 94.6, or about 94.7, or about 94.8, or about 94.9 or about 95.0, or about 95.1 or about 95.2, or about 95.3, or about 95.4, or about 95.5, or about 95.6, or about 95.7, or about 95.8, or about 95.9, or about 96.0, or about 96.1 or about 96.2, or about 96.3, or about 96.4, or about 96.5, or about 96.6, or about 96.7, or about 96.8, or about 96.9, or about 97.0, or about 97.1 or about 97.2, or about 97.3, or about 97.4, or about 97.5, or about 97.6, or about 97.7, or about 97.8, or about 97.9, or about 98.0, or about 98.1 or about 98.2, or about 98.3, or about 98.4, or about 98.5, or about 98.6, or about 98.7, or about 98.8, or about 98.9, or about 99.0, or about 99.1, or about 99.2, or about 99.3, or about 99.4 or about 99.5, or about 99.6, or about 99.7, or about 99.8, or about 99.9, or about 99.91, or about 99.92, or about 99.93, or about 99.94, or about 99.95, or about 99.96, or about 99.97, or about 99.98 percent by weight of the composite hydrogel composition. In the forgoing array of numbers, percent by weight of the solvent may fall in a range of numbers from one number to another number. For example, the percent by weight of the ionic polymer material may be in a range from about 99.3 to about 99.95 percent by weight.

In an aspect, the cationic component may be an acid, a group I salt, a group II salt, a 1-alkyl-3-alkylimidiazolium salt, a 1-alkyl-imidiazolium salt, a 3-alkylimidiazolium salt, a pyrrolidinium salt, a pyridinium salt, and combinations thereof. In an embodiment, an alkyl group may be a C₁ to C₆ alkyl group. The alkyl group may be linear, branched or cyclic. In an aspect, the alkyl group may be methyl, ethyl, propyl, isopropyl, n-butyl, isobutyl, sec butyl, tert-butyl, n-pentyl, or n-hexyl. In an aspect, the C₁ to C₆ alkyl group is optionally substituted with one or more halogen selected from Cl, F, and Br.

In an aspect, the cationic component may comprise an anion which may be a halide anion, a triflate anion, a dicyanamide anion, an acetate anion, a perchlorate anion, a bis-trifluoromethyl sulfonimide (triflimide) anion, or a bis-fluoro sulfonimide anion and combinations thereof. In an aspect, the anion is a triflimide anion.

In another aspect, the cationic component is selected from the group consisting of The reversibly rigid polymer-salt composite hydrogel composition of any one of the foregoing aspects wherein the sodium salt is selected from sodium chloride, sodium triflate, sodium bistriflimide, sodium bis-fluorosulfonimide, sodium dicyanamide, sodium acetate, sodium perchlorate, lithium chloride, lithium triflate, lithium bistriflimide, lithium bis-fluorosulfonimide, lithium dicyanamide, lithium acetate, lithium perchlorate, potassium chloride, potassium triflate, potassium bistriflimide, potassium bis-fluorosulfonimide, potassium dicyanamide, potassium acetate, potassium perchlorate, cesium chloride, cesium triflate, cesium bistriflimide, cesium bis-fluorosulfonimide, cesium dicyanamide, cesium acetate, cesium perchlorate, zinc chloride, zinc triflate, zinc bistriflimide zinc bis-fluorosulfonimide zinc dicyanamide, zinc acetate, zinc perchlorate, magnesium chloride, magnesium triflate, magnesium bistriflimide, magnesium bis-fluorosulfonimide magnesium dicyanamide, magnesium acetate, magnesium perchlorate, calcium chloride, calcium triflate, calcium bistriflimide calcium bis-fluorosulfonimide, calcium dicyanamide, calcium acetate, calcium perchlorate and combinations thereof.

In general, the solvent of the composition is water and/or a second solvent. The solvent may be anhydrous and/or aprotic. In an aspect, the solvent may comprise one or more of: water, dimethyl formamide, N,N-dimethyl acetamide, ethylene glycol, N-methyl pyrrolidone, acetonitrile, ethanol, methanol, ethanol, propanol, isopropanol, butanol, pentanol, ethylene glycol monoethyl ether, ethylene glycol diethyl ether, dioxane, a polyethylene glycol, and/or combinations thereof.

In an aspect, the composite hydrogel may be prepared to have a selected shear storage modulus. The shear storage modulus is measured by the Thermo-Mechanical Characterization Test and/or Rheological Characterization, described below. In general, the shear storage modulus is about 10, about 10², about 10³, about 10⁴, about 10⁵, or about 10⁶ Pascals. In another aspect, the shear storage modulus may be within a range any one number to another in the preceding list, for example from about 10³ Pascals to about 10⁵ Pascals.

In an aspect, the ionic conductivity of the composite hydrogel is from about 1 mS/cm to about 100 mS/cm, or from about 1 mS/cm to about 50 mS/cm, or from about 1 mS/cm to about 40 mS/cm, or from about 1 mS/cm to about 30 mS/cm, or from about 1 mS/cm to about 20 mS/cm, or from about 1 mS/cm to about 10 mS/cm. The ionic conductivity is measured as known to a person of ordinary skill in the art.

In an aspect, when water is a solvent, the melt temperature, or liquification temperature can be about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, about 100, about 101, about 102, about 103, about 104, about 105, about 106, about 107, about 108, about 109, about 110, about 111, about 112, about 113, about 114, about 115, about 116, about 117, about 118, about 119, or about 120 degrees C. In the forgoing array of numbers, the melt temperature may fall in a range of numbers from one number to another number. For example, the melt temperature may be in a range from 75 degrees Centigrade to about 90 degrees Centigrade.

The disclosure will be better understood by reading the following numbered aspects, which should not be confused with the claims. In some instances, one or more aspects may be combined or combined with aspects described elsewhere in the disclosure or aspects from the examples without deviating from the invention. The following listing of exemplary aspects supports and is supported by the disclosure provided.

### NUMBERED ASPECTS

Aspect 1. A reversibly rigid polymer-salt composite hydrogel composition comprising:
an ionic polymer material comprising a sulfonated aramid;
a cationic component comprising a salt, an ionic liquid, or combinations thereof;
a solvent selected from water, a hydrophilic solvent, a polar solvent, a water-miscible solvent, and combinations thereof;
wherein the ionic polymer material is present in an amount of from about 0.05 wt % to about 20.0 wt %;
wherein the cationic component is present in an amount of from about 0.05 wt % to about 20.0 wt %;
wherein the solvent is present in an amount of from about 70 wt % to about 99.90wt %;
wherein the wt % is based on the weight of the ionic polymer material, the cationic component, and the solvent; and
wherein a sum of individual wt % values is 100 wt %.

Aspect 2. The reversibly rigid polymer-salt composite hydrogel composition of aspect 1, wherein the sulfonated aramid is selected from poly(2,2′-disulfonyl-4,4′-benzidine terephthalamide), a substituted poly(2,2′-disulfonyl-4,4′-benzidine.terephthalamide), a chemically modified poly(2,2′-disulfonyl-4,4′-benzidine terephthalamide), and combinations thereof.

Aspect 3. The reversibly rigid polymer-salt composite hydrogel composition of aspect 1 or aspect 2, wherein the sulfonated aramid comprises poly(2,2′-disulfonyl-4,4′-benzidine terephthalamide).

Aspect 4. The reversibly rigid polymer-salt composite hydrogel composition of any one of the foregoing aspects wherein the sulfonated aramid has weight-average molecular weight of from about 2000-10000 g/mol.

Aspect 5. The reversibly rigid polymer-salt composite hydrogel composition of any one of the foregoing aspects wherein the sulfonated aramid has a weight-average molecular weight of from about 10000 g/mol to about 100,000 g/mol.

Aspect 6. The reversibly rigid polymer salt composite hydrogel composition of any one of the foregoing aspects wherein the sulfonated aramid has a polydispersity index of from about 1 to about 2.

Aspect 7. The reversibly rigid polymer salt composite hydrogel composition of any one of the foregoing aspects wherein the sulfonated aramid has a polydispersity index of from about 1 to about 1.5.

Aspect 8. The reversibly rigid polymer salt composite hydrogel composition of any one of the foregoing aspects wherein the sulfonated aramid has a polydispersity index of from or from about 2 to about 5.

Aspect 9. The reversibly rigid polymer-salt composite hydrogel composition of any one of the foregoing aspects wherein the ionic polymer material is present in an amount of from about 0.1 wt % to about 5.0 wt %.

Aspect 10. The reversibly rigid polymer-salt composite hydrogel composition of any one of the foregoing aspects wherein the ionic polymer material is present in an amount of from about 0.1 wt % to about 5.0 wt %.

Aspect 11. The reversibly rigid polymer-salt composite hydrogel composition of any one of the foregoing aspects wherein the ionic polymer material is present in an amount of from about 0.1 wt % to about 2.5 wt %.

Aspect 12. The reversibly rigid polymer-salt composite hydrogel composition of any one of the foregoing aspects wherein the ionic polymer material is present in an amount of from about 0.5 wt % to about 2.5 wt %.

Aspect 13. The reversibly rigid polymer-salt composite hydrogel composition of any one of the foregoing aspects wherein the cationic component is present in an amount of from about 0.2 wt % to about 17.5 wt %.

Aspect 14. The reversibly rigid polymer-salt composite hydrogel composition of any one of the foregoing aspects wherein the cationic component is present in an amount of from about 1 wt % to about 15.0 wt %.

Aspect 15. The reversibly rigid polymer-salt composite hydrogel composition of any one of the foregoing aspects wherein the cationic component is present in an amount of from about 2.5 wt % to about 15.0 wt %.

Aspect 16. The reversibly rigid polymer-salt composite hydrogel composition of any one of the foregoing aspects wherein the cationic component is selected from an acid, a group I salt, a group II salt, a 1-alkyl-3-alkylimidiazolium salt, a 1-alkyl-imidiazolium salt, a 3-alkylimidiazolium salt, a pyrrolidinium salt, a pyridinium salt, and combinations thereof.

Aspect 17. The reversibly rigid polymer-salt composite hydrogel composition of any one of the foregoing aspects wherein the acid is selected from sulfuric acid, nitric acid, phosphoric acid, hydrofluoric acid, hydrochloric acid, hydroiodic acid, hydrobromic acid, triflic acid, and combinations thereof.

Aspect 18. The reversibly rigid polymer-salt composite hydrogel composition of any one of the foregoing aspects wherein the group I salt, the group II salt, the 1-alkyl-3-alkylimidiazolium salt, the 1-alkyl-imidiazolium salt, the 3-alkylimidiazolium salt, the pyrrolidinium salt, or the pyridinium salt comprises a water soluble, non-coordinating anion.

Aspect 19. The reversibly rigid polymer-salt composite hydrogel composition of any one of the foregoing aspects wherein the cationic component comprises a halide anion, a triflate anion, a dicyanamide anion, an acetate anion, a perchlorate anion, a bis-trifluoromethyl sulfonimide (triflimide) anion, or a bis-fluoro sulfonimide anion and combinations thereof

Aspect 20. The reversibly rigid polymer-salt composite hydrogel composition of any one of the foregoing aspects wherein the 1-alkyl-3-alkylimidiazolium salt is a 1-ethyl-3-methylimidiazolium salt.

Aspect 21. The reversibly rigid polymer-salt composite hydrogel composition of any one of the foregoing aspects wherein the 1-alkyl-3-methylimidiazolium salt is selected from the group consisting of 1-ethyl-3-methylimidiazolium chloride, 1-ethyl-3-methylimidiazolium triflate, 1-ethyl-3-methylimidiazolium bistriflimide, 1-ethyl-3-methylimidiazolium bis-fluorosulfonimide, 1-ethyl-3-methylimidiazolium dicyanamide, 1-ethyl-3-methylimidiazolium acetate, 1-ethyl-3-methylimidiazolium perchlorate, 1-butyl-3-methylimidiazolium chloride, 1-butyl-3-methylimidiazolium triflate, 1-butyl-3-methylimidiazolium bistriflimide, 1-butyl-3-methylimidiazolium bis-fluorosulfonimide, 1-butyl-3-methylimidiazolium dicyanamide, 1-butyl-3-methylimidiazolium acetate, 1-butyl-3-methylimidiazolium perchlorate, and combinations thereof.

Aspect 22. The reversibly rigid polymer-salt composite hydrogel composition of any one of the foregoing aspects wherein the group I salt is sodium salt.

Aspect 23. The reversibly rigid polymer-salt composite hydrogel composition of any one of the foregoing aspects wherein the sodium salt is selected from sodium chloride, sodium triflate, sodium bistriflimide, sodium bis-fluorosulfonimide, sodium dicyanamide, sodium acetate, sodium perchlorate, lithium chloride, lithium triflate, lithium bistriflimide, lithium bis-fluorosulfonimide, lithium dicyanamide, lithium acetate, lithium perchlorate, potassium chloride, potassium triflate, potassium bistriflimide, potassium bis-fluorosulfonimide, potassium dicyanamide, potassium acetate, potassium perchlorate, cesium chloride, cesium triflate, cesium bistriflimide, cesium bis-fluorosulfonimide, cesium dicyanamide, cesium acetate, cesium perchlorate, zinc chloride, zinc triflate, zinc bistriflimide zinc bis-fluorosulfonimide zinc dicyanamide, zinc acetate, zinc perchlorate, magnesium chloride, magnesium triflate, magnesium bistriflimide, magnesium bis-fluorosulfonimide magnesium dicyanamide, magnesium acetate, magnesium perchlorate, calcium chloride, calcium triflate, calcium bistriflimide calcium bis-fluorosulfonimide, calcium dicyanamide, calcium acetate, calcium perchlorate and combinations thereof.

Aspect 24. The reversibly rigid polymer-salt composite hydrogel composition of any one of the foregoing aspects wherein the solvent comprises about 50 wt % to about 100 wt % water; and wherein the wt % of water is based on the total weight of the solvent.

Aspect 25. The reversibly rigid polymer-salt composite hydrogel composition of any one of the foregoing aspects wherein the polymer-salt composite hydrogel composition comprises from about 95 wt % to about 100 wt % solvent.

Aspect 26. The reversibly rigid polymer-salt composite hydrogel composition of any one of the foregoing aspects wherein the solvent comprises water.

Aspect 27. The reversibly rigid polymer-salt composite hydrogel composition of any one of the foregoing aspects wherein the solvent is selected from dimethyl formamide, ethylene glycol, N-methyl pyrrolidone, acetonitrile, ethanol, methanol, and combinations thereof.

Aspect 28. The reversibly rigid polymer-salt composite hydrogel composition of any one of the foregoing aspects wherein the solvent comprises a first solvent comprising water and a second solvent selected from a hydrophilic solvent, a polar solvent, a water-miscible solvent, and combinations thereof.

Aspect 29. The reversibly rigid polymer-salt composite hydrogel composition of any one of the foregoing aspects wherein the second solvent is selected from dimethyl formamide, ethylene glycol, N-methyl pyrrolidone, acetonitrile, ethanol, methanol, and combinations thereof.

Aspect 30. The reversibly rigid polymer-salt composite hydrogel composition of any one of the foregoing aspects wherein the polymer-salt composite hydrogel has an ionic conductivity of from about 1 mS/cm to about 50 mS/cm.

Aspect 31. The reversibly rigid polymer-salt composite hydrogel composition of any one of the foregoing aspects wherein the polymer-salt composite hydrogel has an ionic conductivity of from about 1 mS/cm to about 20 mS/cm.

Aspect 32. The reversibly rigid polymer-salt composite hydrogel composition of any one of the foregoing aspects wherein the polymer-salt composite hydrogel has an ionic conductivity of from about 1 mS/cm to about 10 mS/cm.

Aspect 33. The reversibly rigid polymer-salt composite hydrogel composition of any one of the foregoing aspects wherein the polymer-salt composite hydrogel has an ionic conductivity of from about 1 mS/cm to about 8 mS/cm.

Aspect 34. The reversibly rigid polymer-salt composite hydrogel composition of any one of the foregoing aspects wherein the polymer-salt composite hydrogel has a shear storage modulus (G′) of from about 10¹ to about 10⁷ Pa, or from about 10² to about 10⁸ Pa.

Aspect 35. The reversibly rigid polymer-salt composite hydrogel composition of any one of the foregoing aspects wherein after heating the solid polymer-salt composite hydrogel of an original storage modulus to a liquid phase, the liquid phase reverts upon cooling to room temperature to a solid of a recovered storage modulus which is from about 70% to about 100% of the original storage modulus.

Aspect 36. The reversibly rigid polymer salt composite hydrogel of any one of the foregoing aspects wherein the recovered storage modulus is from about 80% to about 100% of the original storage modulus.

Aspect 37. The reversibly rigid polymer salt composite hydrogel of any one of the foregoing aspects wherein the recovered storage modulus is from about 90% to about 100% of the original storage modulus.

Aspect 38. The reversibly rigid polymer salt composite hydrogel of any one of the foregoing aspects wherein the recovered storage modulus is from about 90% to about 95% of the original storage modulus.

Aspect 39. The reversibly rigid polymer salt composite hydrogel of any one of the foregoing aspects wherein the recovered storage modulus is from about 95% to about 100% of the original storage modulus.

Aspect 40. An article comprising the reversibly rigid polymer-salt composite hydrogel composition of any one of the foregoing aspects.

Aspect 41. The article of claim 40, wherein the article is selected from a personal care product, an artificial tissue or tissue replacement, a tissue growth scaffold, a biosensor, a heavy metal remediation material, a wound dressing, a drug delivery formulation or device, and a lubricant.

Aspect 42. A shaped article comprising the reversibly rigid polymer salt composite hydrogel composition of any one of the foregoing aspects.

Aspect 43. A method of making the reversibly rigid polymer-salt composite hydrogel composition of any one of the foregoing aspects wherein comprising combining an ionic polymer material comprising a sulfonated aramid and a solvent at a temperature and time to prepare a homogeneous solution comprising from about 0.05 wt % to about 20.0 wt % of an ionic polymer material comprising a sulfonated aramid; cooling the homogeneous solution; and adding the cationic component in an amount of from about 0.05 wt % to about 20.0 wt % to form a second homogeneous solution.

Aspect 44. The method of any one of the foregoing aspects further comprising heating the second homogeneous solution to an elevated temperature and holding the second homogeneous for a period of time.

Aspect 45. The method of any one of the foregoing aspects further comprising cooling the second homogeneous solution to about room temperature.

Aspect 46. A solid reversibly rigid polymer-salt composite hydrogel composition comprising:
an ionic polymer material comprising a sulfonated aramid;
a cationic component comprising a salt, an ionic liquid, or combinations thereof;
a solvent selected from water, a hydrophilic solvent, a polar solvent, a water-miscible solvent, and combinations thereof;
wherein the ionic polymer material is present in an amount of from about 0.05 wt % to about 20.0 wt %;
wherein the cation component is present in an amount of from about 0.05 wt % to about 20.0 wt %;
wherein the solvent is present in an amount of from about 70 wt % to about 99.90wt %;
wherein the wt % is based on the weight of the ionic polymer material, the cationic component, and the solvent;
wherein a sum of individual wt % values is 100 wt %; and
wherein a storage modulus of the solid reversibly rigid polymer-salt composite hydrogel is greater than a loss modulus of the solid reversibly rigid polymer-salt composite hydrogel as measured by a compressive oscillatory rheology method.

Aspect 47. The solid reversibly rigid polymer-salt composite hydrogel composition of claim 46, wherein the storage modulus and loss modulus are measured from 10⁻¹ to 10² rad/sec.

Aspect 48. The solid reversibly rigid polymer-salt composite hydrogel composition of claim 46 or claim 47, wherein solidity of the solid polymer-salt composite hydrogel composition is measured by a visual vial inversion test.

Aspect 49. The solid reversibly rigid polymer-salt composite hydrogel composition of any one of claims 46-48, wherein the solid reversibly rigid polymer-salt composite hydrogel reverts upon cooling to about 20° C. to 70° C. to a solid of a recovered storage modulus which is from about 70% to about 100% of an original storage modulus; and wherein the cooling is after heating the solid reversibly rigid polymer-salt composite hydrogel of the original storage modulus to a liquid phase.

Aspect 50. The solid reversibly rigid polymer salt composite hydrogel of any one of claims 46-49 wherein the recovered storage modulus is from about 80% to about 100% of the original storage modulus.

Aspect 51. The solid reversibly rigid polymer salt composite hydrogel of any one of claims 46-50, wherein the recovered storage modulus is from about 90% to about 100% of the original storage modulus.

Aspect 52. The solid reversibly rigid polymer salt composite hydrogel of any one of claims 46-51, wherein the recovered storage modulus is from about 90% to about 95% of the original storage modulus.

Aspect 53. The solid reversibly rigid polymer salt composite hydrogel of any one of claims 46-52 wherein the recovered storage modulus is from about 95% to about 100% of the original storage modulus.

Aspect 54. The solid reversibly rigid polymer-salt composite hydrogel composition of any one of claims 46-53 wherein the sulfonated aramid has weight-average molecular weight of from about 2000-10000 g/mol.

Aspect 55. The solid reversibly rigid polymer-salt composite hydrogel composition of any one of claims 46-54 wherein the sulfonated aramid has a weight-average molecular weight of from about 10000 g/mol to about 100,000 g/mol.

Aspect 56. The solid reversibly rigid polymer salt composite hydrogel composition of any one of claims 46-55, wherein the sulfonated aramid has a polydispersity index of from about 1 to about 2.

Aspect 57. The solid reversibly rigid polymer salt composite hydrogel composition of any one of claims 46-56 wherein the sulfonated aramid has a polydispersity index of from about 1 to about 1.5.

Aspect 58. The solid reversibly rigid polymer salt composite hydrogel composition of any one of claims 46-57 wherein the sulfonated aramid has a polydispersity index of, or from about 2 to about 5.

Aspect 59. The solid reversibly rigid polymer-salt composite hydrogel composition of any one of claims 46-58 wherein the sulfonated aramid comprises poly(2,2′-disulfonyl-4,4′-benzidine terephthalamide).

Aspect 60. The solid reversibly rigid polymer salt composite hydrogel according to any one of claims 46-59 wherein the solidity is maintained for a period of time of from 1 to 180 days, or from 1 to 90 days, or from 1 to 30 days, or from 1 to 7 days, or 1 day, or 2 days, or 3 days, or 4 days, or 5 days, or 6 days.

Aspect 61. The reversibly rigid polymer salt composite hydrogel according to any one of claims 1-45 wherein the hydrogel is a solid, according to the visual vial inversion test, and remains solid for a period of time of from 1 to 180 days, or from 1 to 90 days, or from 1 to 30 days, or from 1 to 7 days, or 1 day, or 2 days, or 3 days, or 4 days, or 5 days, or 6 days.

### EXAMPLES

Materials: PBDT was synthesized from 2,2′-benzidinedisulfonate acid (HBDSA) and estimated to have an M_{w}˜17 kg/mol from viscosity measurements. When dissolved in water, the solutions showed a pure nematic liquid crystalline phase at 2.0 wt % PBDT. 1-ethyl-3-methylimidazolium triflate (C₂mimTfO) IL was purchased from IoLiTec GmbH with purity >99%.

Preparation of PBDT-IL Hydrogels: Hydrogels produced with as much as 97 wt % H₂O were made by first combining PBDT and H₂O in a vial. The resulting solution was heated to 65° C. for 1 day allowing the solutions to become homogenous. These aqueous solutions were then cooled to room temperature and the IL, C₂mimTfO, was added to the PBDT solutions. Depending on the amount of IL added the solutions would either gel or remain a solution, at room temperature. All the solutions were then placed back into an oven, at 65° C., to ensure all samples that gelled would melt. The solutions of PBDT, IL, and H₂O were kept at 65° C., overnight, until homogeneous. Once homogeneous the vials were removed from the oven and kept at various temperatures, including room temperature and the human body's biological temperature (37° C.), to look for flow and then produce a phase diagram describing the sol-gel transitions.

Thermo-Mechanical Characterization (Test): TA Instruments ARES G2 strain-controlled rheometer equipped with a Peltier thermoelectric temperature control system was used for rheological measurements. The top plate geometry was a roughened 8 mm diameter aluminum parallel plate and the bottom plate was a 60 mm chromium-plated Peltier plate. Samples approximately 1 mm in thickness were cut from the as-made hydrogels and loaded into the rheometer followed by trimming with a razor blade. Trimming of the edges had no observable effect on the measured modulus values. Various sample thicknesses between 0.5 to 1.5 mm were tested and no gap-dependent effects were observed. The sample edges were coated with a low viscosity silicone oil to prevent solvent evaporation. Strain amplitude sweeps determined the linear viscoelastic regime (LVR) for a select set of hydrogels, and a strain amplitude within the LVR of 1% was chosen for subsequent measurements. Isothermal frequency sweeps were conducted at 25° C. from 100 to 0.1 rad s⁻¹ and temperature ramps between 25 and 80° C. were measured at a frequency of 10 rad s⁻¹ and a heating rate of 1° C. min⁻¹. Variable axial forces were applied depending on the sample stiffness to ensure good contact between sample and transducer, while preventing excessive compression of the hydrogel.

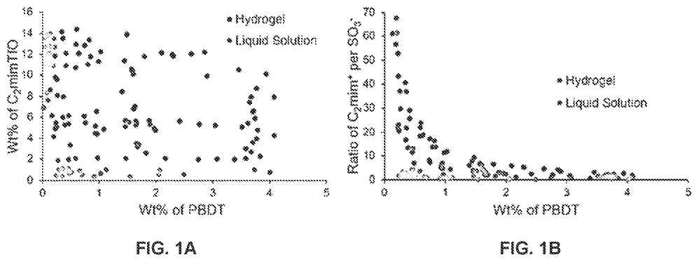

PBDT-IL hydrogels were prepared using an analogous method to that reported by D. Yu et al for fabrication of MIC ion gels.²⁸ Using this “one-pot” formation method, we dissolve the required amount of PBDT in water. After allowing the solution to become homogeneous, in an oven, the required amount of IL, C₂mimTfO, was added to the PBDT solution. After time passed (typically >12 hours) the vial containing the combined solution of PBDT, H₂O, and C₂mimTfO was removed from the oven and left at room temperature to gel. The resulting hydrogel was generally formed in less than two minutes as the solution cooled to room temperature. To test whether the composite hydrogel had truly (completely) gelled, the vials were tested according the visual vial inversion test. The vials were inverted for about 10 minutes. A hydrogel that visibly shows no movement or flow of material down the walls of the vial is considered truly (completely) gelled. In all systems that formed a hydrogel, the inverted composites resisted flow for as long as they were left inverted, which for many cases was as long as a week. Hydrogels were formed with PBDT content of 0.1 wt % up to 15 wt % with the amount of water used to form the hydrogel being ≤97 wt %. A room temperature phase diagram for these PBDT, IL, and water systems (to describe the amount of PBDT and IL needed for gelation) is shown in FIG. 1A.

The phase diagram of these hydrogels at room temperature indicate trends in both the minimum amount of IL and PBDT required to cause gelation in these composites. This is likely due to the IL cross-linking the system together through the negatively charged PBDT rigid rods. An investigation of ratios of IL cation, C₂mim⁺, to the negatively charged sulfonate groups, SO₃⁻, on the PBDT rod are shown in FIG. 1B. When a small amount of PBDT was used (<0.5 wt %), the ratio of IL cation to sulfonate group (SO₃⁻), on the PBDT rod was found to be between 6 and 60 to form a hydrogel. As the amount of PBDT was increased (>1.5 wt %), the ratio of IL cation to sulfonate group was able to be decreased to as low as 0.5.

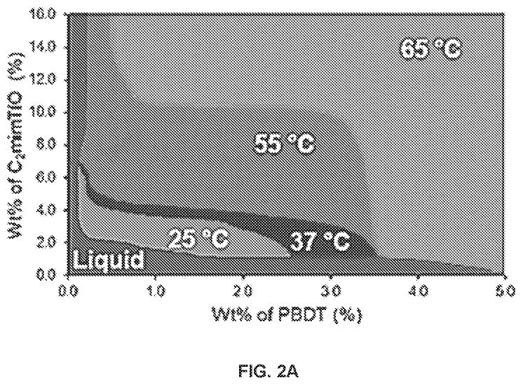

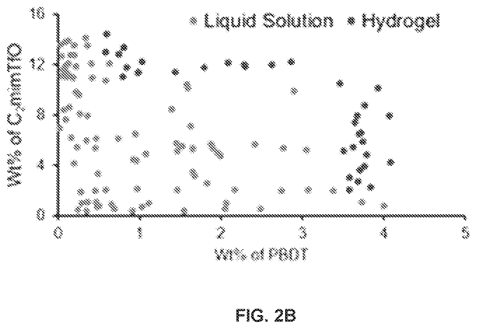

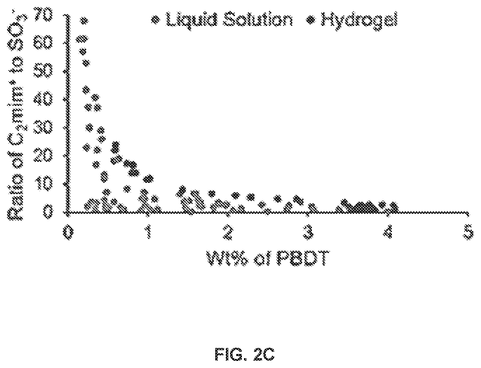

Effect of Temperature: Four different temperatures, 37, 45, 55, and 65° C., were used to investigate sol-gel transitions, as shown in FIG. 2A. The vial inversion method, again, was used to insure gelation. As shown in FIG. 2B, at 65° C., many of the compositions that were hydrogels at lower temperature became liquids (melts). The measurement of the ratio C₂mim⁺ to SO₃⁺ groups on the PBDT backbone, shown in FIG. 2C, indicated sol-gel transition boundaries. At 65° C., any system below 0.5 wt % of PBDT did not gel regardless of the amount of IL used.

Rheological Characterization: To understand the mechanical strength and integrity of the hydrogels, two different systematic sets of samples were studied. In the first set of samples the IL content constant was held at 5.00 wt % while the PBDT wt % varied from 0.2 wt % to 2.0 wt %. In the second set of samples the PBDT content was held constant at 1.50 wt %, while varying the IL content, from 3.50 to 10.00 wt %. Both samples were measured using an oscillatory compression method, in which 1 mm height discs of hydrogels were placed between 8 mm parallel plates. A top plate roughed with sandpaper was used to ensure proper sample contact throughout the experiments. Strain amplitude sweeps were performed on parallel plates that either used sandpaper or a roughed stainless-steel surface as the interface to the sample. Covering the sample in low viscosity silicone oil allowed for little to no water evaporation over several hours. Isothermal frequency sweeps conducted at 25° C., ranging from 100 to 0.1 rad s⁻¹ were designed to ensure the measurements were made within a linear viscoelastic regime. Such testing was to confirm whether a sample could be considered solid under the definition of a measured storage modulus (G′) greater than a loss modulus (G″).

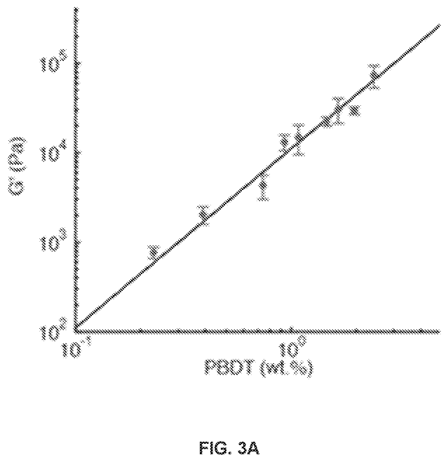

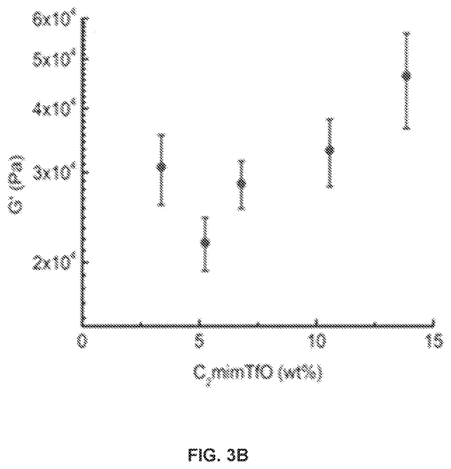

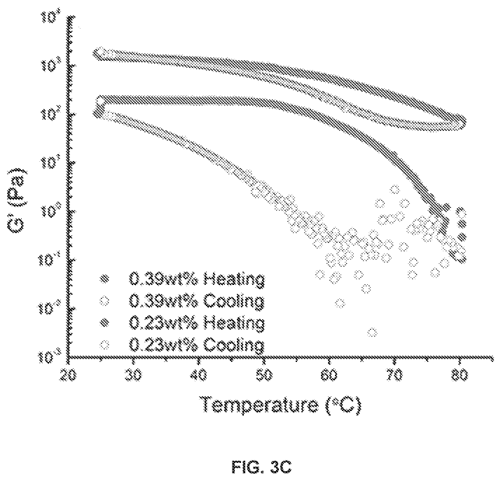

FIG. 3A shows how the modulus of the hydrogels varied as a function of PBDT wt %. The experimental error was generated from measuring three different discs cut from the hydrogel sample. The elastic modulus increased with PBDT content, and this increase fit well to a power law of 5/2 which is close to a scaling prediction for entangled polymer solutions, of 2.3. Compared to other physically cross-linked hydrogels, with similar ionic concentration, there was an unexpectedly strong hydrogel at very low polymer content, in which a 1 wt % PBDT sample (0.01 g/mL) produced a modulus of 14 kPa. Even at extremely low polymer content, ≈0.2 wt %, the composite hydrogel had a modulus of 1 kPa.

### REFERENCES

### REFERENCES

1. Naahidi, S.; Jafari, M.; Logan, M.; Wang, Y.; Yuan, Y.; Bae, H.; Dixon, B.; Chen, P., Biocompatibility of hydrogel-based scaffolds for tissue engineering applications. Biotechnology advances 2017, 35 (5), 530-544.
2. Huang, H.; Qi, X.; Chen, Y.; Wu, Z., Thermo-sensitive hydrogels for delivering biotherapeutic molecules: A review. Saudi Pharmaceutical Journal 2019, 27(7), 990-999.
3. Klouda, L.; Mikos, A. G., Thermoresponsive hydrogels in biomedical applications. Eur J Pharm Biopharm 2008, 68 (1), 34-45.
4. Akhtar, M. F.; Hanif, M.; Ranjha, N. M., Methods of synthesis of hydrogels. . . . A review. Saudi Pharmaceutical Journal 2016, 24 (5), 554-559.
5. Utech, S.; Boccaccini, A. R., A review of hydrogel-based composites for biomedical applications: enhancement of hydrogel properties by addition of rigid inorganic fillers. Journal of Materials Science 2016, 51 (1), 271-310.
6. Antoine, E. E.; Vlachos, P. P.; Rylander, M. N., Review of Collagen I Hydrogels for Bioengineered Tissue Microenvironments: Characterization of Mechanics, Structure, and Transport. Tissue Engineering Part B: Reviews 2014, 20 (6), 683-696.
7. Liu, K.; Wei, S.; Song, L.; Liu, H.; Wang, T., Conductive Hydrogels—A Novel Material: Recent Advances and Future Perspectives. Journal of Agricultural and Food Chemistry 2020, 68 (28), 7269-7280.
8. Kopeček, J., Hydrogel biomaterials: A smart future? Biomaterials 2007, 28 (34), 5185-5192.
9. Hua, J.; Ng, P. F.; Fel, B., High-strength hydrogels: Microstructure design, characterization and applications. Journal of Polymer Science Part B: Polymer Physics 2018, 56 (19), 1325-1335.
10. Mondal, S.; Das, S.; Nandi, A. K., A review on recent advances in polymer and peptide hydrogels. Soft Matter 2020, 16 (6), 1404-1454.
11. Peak, C. W.; Wilker, J. J.; Schmidt, G., A review on tough and sticky hydrogels. Colloid and Polymer Science 2013, 291 (9), 2031-2047.
12. Su, G.; Zhou, T.; Liu, X.; Ma, Y., Micro-dynamics mechanism of the phase transition behavior of poly(N-isopropylacrylamide-co-2-hydroxyethyl methacrylate) hydrogels revealed by two-dimensional correlation spectroscopy. Polymer Chemistry 2017, 8 (5), 865-878.
13. Park, Y.; Hashimoto, C.; Hashimoto, T.; Hirokawa, Y.; Jung, Y. M.; Ozaki, Y., Reaction-Induced Self-Assembly of Gel Structure: A New Insight into Chemical Gelation Process of N-Isopropylacrylamide as Studied by Two-Dimensional Infrared Correlation Spectroscopy. Macromolecules 2013, 46 (9), 3587-3602.
14. Sun, T. L.; Kurokawa, T.; Kuroda, S.; Ihsan, A. B.; Akasaki, T.; Sato, K.; Haque, M. A.; Nakajima, T.; Gong, J. P., Physical hydrogels composed of polyampholytes demonstrate high toughness and viscoelasticity. Nature Materials 2013, 12(10), 932-937.
15. Su, G.; Jia, L.; Zhang, X.; Zhang, Y.; Deng, P.; Zhou, T., Exploration of the unusual two-step volume phase transition of the poly(N-vinylcaprolactam-co-hydroxyethyl methacrylate) hydrogel. Physical Chemistry Chemical Physics 2018, 20 (35), 23013-23024.
16. Chen, W.-P.; Hao, D.-Z.; Hao, W.-J.; Guo, X.-L.; Jiang, L., Hydrogel with Ultrafast Self-Healing Property Both in Air and Underwater. ACS Applied Materials & Interfaces 2018, 10 (1), 1258-1265.
17. Zhang, H. J.; Sun, T. L.; Zhang, A. K.; Ikura, Y.; Nakajima, T.; Nonoyama, T.; Kurokawa, T.; Ito, O.; Ishitobi, H.; Gong, J. P., Tough Physical Double-Network Hydrogels Based on Amphiphilic Triblock Copolymers. Advanced Materials 2016, 28 (24), 4884-4890.
18. Takahashi, R.; Ikai, T.; Kurokawa, T.; King, D. R.; Gong, J. P., Double network hydrogels based on semi-rigid polyelectrolyte physical networks. Journal of Materials Chemistry B 2019, 7 (41), 6347-6354.
19. Miguel, S. P.; Moreira, A. F.; Correia, I. J., Chitosan based-asymmetric membranes for wound healing: A review. International Journal of Biological Macromolecules 2019, 127, 460-475.
20. Shoulders, M. D.; Raines, R. T., Collagen structure and stability. Annu Rev Biochem 2009, 78, 929-958.
21. Sarrigiannidis, S. O.; Rey, J. M.; Dobre, O.; González-García, C.; Dalby, M. J.; Salmeron-Sanchez, M., A tough act to follow: collagen hydrogel modifications to improve mechanical and growth factor loading capabilities. Materials Today Bio 2021, 10, 100098.
22. Jia, Y.-G.; Jin, J.; Liu, S.; Ren, L.; Luo, J.; Zhu, X. X., Self-Healing Hydrogels of Low Molecular Weight Poly(vinyl alcohol) Assembled by Host-Guest Recognition. Biomacromolecules 2018, 19 (2), 626-632.
23. Yang, W.; Furukawa, H.; Gong, J. P., Highly Extensible Double-Network Gels with Self-Assembling Anisotropic Structure. Advanced Materials 2008, 20 (23), 4499-4503.
24. Wang, Y.; He, Y.; Yu, Z.; Gao, J.; ten Brinck, S.; Slebodnick, C.; Fahs, G. B.; Zanelotti, C. J.; Hegde, M.; Moore, R. B.; Ensing, B.; Dingemans, T. J.; Qiao, R.; Madsen, L. A., Double helical conformation and extreme rigidity in a rodlike polyelectrolyte. Nature Communications 2019, 10 (1), 801.
25. Wang, Y.; Chen, Y.; Gao, J.; Yoon, H. G.; Jin, L.; Forsyth, M.; Dingemans, T. J.; Madsen, L. A., Highly Conductive and Thermally Stable Ion Gels with Tunable Anisotropy and Modulus. Advanced Materials 2016, 28 (13), 2571-2578.
26. Bostwick, J. E.; Zanelotti, C. J.; Iacob, C.; Korovich, A. G.; Madsen, L. A.; Colby, R. H., Ion Transport and Mechanical Properties of Non-Crystallizable Molecular Ionic Composite Electrolytes. Macromolecules 2020, 53 (4), 1405-1414.
27. Fox, R. J.; Yu, D.; Hegde, M.; Kumbhar, A. S.; Madsen, L. A.; Dingemans, T. J., Nanofibrillar Ionic Polymer Composites Enable High-Modulus Ion-Conducting Membranes. ACS Applied Materials & Interfaces 2019, 11 (43), 40551-40563.
28. Yu, D.; Zanelotti, C. J.; Fox, R. J.; Dingemans, T. J.; Madsen, L. A., Solvent-Cast Solid Electrolyte Membranes Based on a Charged Rigid-Rod Polymer and Ionic Liquids. ACS Applied Energy Materials 2021.
29. Yu, D., Pan, X.; Bostwick, J.; Zanelotti, C.; Mu, L.; Colby, R.; Lin, F.; Madsen, L., Room Temperature to 150° C. Lithium Metal Batteries Enabled by a Rigid Molecular Ionic Composite Electrolyte. Advanced Energy Materials 2021, 11, 2003559.
30. Wang, Y.; Zanelotti, C.; Wang, X.; Kerr, R.; Jin, L.; Kan, W.; Dingemans, T.; Forsyth, M.; Madsen, L., Solid-state rigid-rod polymer composite electrolytes with nanocrystalline lithium ion pathways. Nature Materials 2021, 1-9.

1. A reversibly rigid polymer-salt composite hydrogel composition comprising:
an ionic polymer material comprising a sulfonated aramid;
a cationic component comprising a salt, an ionic liquid, or combinations thereof;
a solvent selected from water, a hydrophilic solvent, a polar solvent, a water-miscible solvent, and combinations thereof;
wherein the ionic polymer material is present in an amount of from about 0.05 wt % to about 20.0 wt %;
wherein the cationic component is present in an amount of from about 0.05 wt % to about 20.0 wt %;
wherein the solvent is present in an amount of from about 70 wt % to about 99.90 wt %;
wherein the wt % is based on the weight of the ionic polymer material, the cationic component, and the solvent; and
wherein a sum of individual wt % values is 100 wt %.

2. The reversibly rigid polymer-salt composite hydrogel composition of claim 1, wherein the sulfonated aramid is selected from poly(2,2′-disulfonyl-4,4′-benzidine terephthalamide), a substituted poly(2,2′-disulfonyl-4,4′-benzidine terephthalamide), a chemically modified poly(2,2′-disulfonyl-4,4′-benzidine terephthalamide), and combinations thereof.

3. The reversibly rigid polymer-salt composite hydrogel composition of claim 2, wherein the sulfonated aramid comprises poly(2,2′-disulfonyl-4,4′-benzidine terephthalamide).

4. The reversibly rigid polymer-salt composite hydrogel composition of claim 1 wherein the sulfonated aramid has weight-average molecular weight of from about 2000-10000 g/mol.

5. (canceled)

6. The reversibly rigid polymer salt composite hydrogel composition of claim 1 wherein the sulfonated aramid has a polydispersity index of from about 1 to about 2.

7. The reversibly rigid polymer salt composite hydrogel composition of claim 1 wherein the sulfonated aramid has a polydispersity index of from about 1 to about 1.5.

8. (canceled)

9. The reversibly rigid polymer-salt composite hydrogel composition claim 1 wherein the ionic polymer material is present in an amount of from about 0.1 wt % to about 5.0 wt %.

10. (canceled)

11. (canceled)

12. (canceled)

13. The reversibly rigid polymer-salt composite hydrogel composition of claim 1 wherein the cationic component is present in an amount of from about 0.2 wt % to about 17.5 wt %.

14. (canceled)

15. (canceled)

16. The reversibly rigid polymer-salt composite hydrogel composition of claim 1, wherein the cationic component is selected from an acid, a group I salt, a group II salt, a 1-alkyl-3-alkylimidiazolium salt, a 1-alkyl-imidiazolium salt, a 3-alkylimidiazolium salt, a pyrrolidinium salt, a pyridinium salt, and combinations thereof.

17. The reversibly rigid polymer-salt composite hydrogel composition of claim 16, wherein the acid is selected from sulfuric acid, nitric acid, phosphoric acid, hydrofluoric acid, hydrochloric acid, hydroiodic acid, hydrobromic acid, triflic acid, and combinations thereof.

18. The reversibly rigid polymer-salt composite hydrogel composition of claim 16, wherein the group I salt, the group II salt, the 1-alkyl-3-alkylimidiazolium salt, the 1-alkyl-imidiazolium salt, the 3-alkylimidiazolium salt, the pyrrolidinium salt, or the pyridinium salt comprises a water soluble, non-coordinating anion.

19. The reversibly rigid polymer-salt composite composition of claim 16 wherein the cationic component comprises a halide anion, a triflate anion, a dicyanamide anion, an acetate anion, a perchlorate anion, a bis-trifluoromethyl sulfonimide (triflimide) anion, or a bis-fluoro sulfonimide anion and combinations thereof

20. (canceled)

21. (canceled)

22. The reversibly rigid polymer-salt composite hydrogel composition of claim 16, wherein the group I salt is sodium salt.

23. The reversibly rigid polymer-salt composite hydrogel composition of claim 22, wherein the sodium salt is selected from sodium chloride, sodium triflate, sodium bistriflimide, sodium bis-fluorosulfonimide, sodium dicyanamide, sodium acetate, sodium perchlorate, lithium chloride, lithium triflate, lithium bistriflimide, lithium bis-fluorosulfonimide, lithium dicyanamide, lithium acetate, lithium perchlorate, potassium chloride, potassium triflate, potassium bistriflimide, potassium bis-fluorosulfonimide, potassium dicyanamide, potassium acetate, potassium perchlorate, cesium chloride, cesium triflate, cesium bistriflimide, cesium bis-fluorosulfonimide, cesium dicyanamide, cesium acetate, cesium perchlorate, zinc chloride, zinc triflate, zinc bistriflimide zinc bis-fluorosulfonimide zinc dicyanamide, zinc acetate, zinc perchlorate, magnesium chloride, magnesium triflate, magnesium bistriflimide, magnesium bis-fluorosulfonimide magnesium dicyanamide, magnesium acetate, magnesium perchlorate, calcium chloride, calcium triflate, calcium bistriflimide calcium bis-fluorosulfonimide, calcium dicyanamide, calcium acetate, calcium perchlorate and combinations thereof.

24. The reversibly rigid polymer-salt composite hydrogel composition of claim 1 wherein the solvent comprises about 50 wt % to about 100 wt % water; and wherein the wt % of water is based on the total weight of the solvent.

25. The reversibly rigid polymer-salt composite hydrogel composition of claim 24, wherein the polymer-salt composite hydrogel composition comprises from about 95 wt % to about 100 wt % solvent.

26. (canceled)

27. The reversibly rigid polymer-salt composite hydrogel composition of claim 2 wherein the solvent is selected from dimethyl formamide, ethylene glycol, N-methyl pyrrolidone, acetonitrile, ethanol, methanol, and combinations thereof.

28. (canceled)

29. The reversibly rigid polymer-salt composite hydrogel composition of claim 28, wherein the second solvent is selected from dimethyl formamide, ethylene glycol, N-methyl pyrrolidone, acetonitrile, ethanol, methanol, and combinations thereof.

30. (canceled)

31. (canceled)

32. (canceled)

33. (canceled)

34. (canceled)

35. (canceled)

36. (canceled)

37. (canceled)

38. (canceled)

39. (canceled)

40. An article comprising the reversibly rigid polymer-salt composite hydrogel composition of claim 1.

41. (canceled)

42. (canceled)

43. A method of making the reversibly rigid polymer-salt composite hydrogel composition of claim 1, the method comprising combining an ionic polymer material comprising a sulfonated aramid and a solvent at a temperature and time to prepare a homogeneous solution comprising from about 0.05 wt % to about 20.0 wt % of an ionic polymer material comprising a sulfonated aramid; cooling the homogeneous solution; and adding the cationic component in an amount of from about 0.05 wt % to about 20.0 wt % to form a second homogeneous solution.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
